(19) United States
(12) Patent Application Publication
(10) Pub. No.: US 2013/0036021 A1
(43) Pub. Date: Feb. 7, 2013

(54) METHOD AND SYSTEM FOR INVESTOR SOCIAL NETWORK, FORUM AND VIRTUAL MARKETPLACE

(71) Applicant: Peter A. Wright, Needham, MA (US)

(72) Inventor: Peter A. Wright, Needham, MA (US)

(21) Appl. No.: 13/563,900

(22) Filed: Aug. 1, 2012

Related U.S. Application Data
(60) Provisional application No. 61/515,147, filed on Aug. 4, 2011.

(51) Int. Cl. G06Q 30/08

(52) U.S. Cl. 705/26.3

(57) ABSTRACT

A computer implemented system and method for conducting and disseminating financial research products and services among users in an investment community includes a social network module configured to store electronic user files for each of the users, and to generate a network user interface configured to enable communication among the users via the users' client computers in real time and/or asynchronously. A forum module stores and displays selected media including selections of the communication among the users. A virtual auction module enables users to generate proposals for desired financial research products or services, view the proposals, bid on the proposals, and collaborate on the proposals, in real-time and/or asynchronously. A dashboard module is configured to generate an electronic dashboard configured to track and selectively display status of the electronic user files, including enabling users to selectively access the social network, forum and virtual auction modules in real-time.

### RELATED APPLICATION

This application claims the benefit of U.S. Provisional Patent Application Ser. No. 61/515,147, entitled Method and System for Investor Social Network, Forum and Virtual Marketplace, filed on Aug. 4, 2011, the contents of which are incorporated herein by reference in their entirety for all purposes.

### BACKGROUND

1. Technical Field

Aspects of the present invention relate to methods and systems for conducting and disseminating financial research among members of the investment community and, specifically, to methods and systems for performing financial research and related services that reduce information redundancy and information overload, that are customizable and pull-driven, and that are user friendly and affordable.

2. Background Information

There are a number of problems facing the research investment community today. Chief among these problems is information overload, which prevents the investment community from using its most valuable resources, namely, time, knowledge and capital. The problem of information overload was exacerbated over the last 10 years or so and, and more specifically, after regulations were passed after the turn of the century that changed the manner in which the investment community conducts research. Regulations, such as Regulation FD and implementation of Chinese Walls within Banks, for example, have led to a number of drawbacks including: investment research lacking customization, as research is now more standard in form and content as corporate information has to be disseminated to the Street through a public (simultaneous) forum; corporate access being delivered in a push versus pull process in an effort to avoid unfair disclosures; and difficulties in investing internationally due to regulatory differences, among other drawbacks.

As another example, during the post-2000 period, mostly due to the implemented investment community regulations, the roles of the financial analyst and reporter have almost reversed. While pre-2000 Street analysts would bring news to the market and financial reporters (e.g., Bloomberg News) would report on these facts the next day. Today, the situation is almost reversed, with financial reporters performing the original analysis and Street analysts sharing commentary the next day.

Thus, the regulations implemented over the past ten years have led, at least in part, to an enormous amount of information redundancy, e.g., the existence of tens or more reports containing the same basic information and analyzing the same basic set of facts. This redundancy is at least partially the cause of the current information overload. The existing redundancy is preventing financial research—which used to be the center of profitability pre-2000—from playing a significant role in the profitability equation today.

In addition, to the lack of customization of investment research, given the pricing of standard investment research, customized market research would be prohibitively expensive. There is a need in the art, therefore, for methods and systems for conducting and disseminating financial research in a manner that reduces redundancy and information overload. There is a further need in the art for methods and systems for performing financial research that are customizable and based on the needs of a specific investor/client. There is yet a further need in the art for methods and systems for performing financial research that are pull-rather than push driven, i.e., information is provided based on a specific investor's needs, rather than just providing a standardized research/information product. There is yet a further need in the art for methods and systems for financial research that are user friendly and affordable, at least on the order of standard research.

Aspects of the present invention solve the above-identified needs, as well as others, by providing methods and systems for conducting financial research by reducing redundancy and information overload in the financial investment community. In addition, aspects of the present invention provide methods and systems for performing financial research that are customizable and pull- rather than push-driven, thereby providing investors, for example, with information the investors want to consume. Further, aspects of the present invention provide methods and systems for financial research that are user friendly and affordable.

Additional advantages and novel features of the invention will be set forth in part in the description that follows, and in part will become more apparent to those skilled in the art upon examination of the following or upon learning by practice of the invention.

### SUMMARY

In one aspect of the present invention, a computer implemented system in a client-server environment, is provided for conducting and disseminating financial research products and services among users in an investment community. The system includes a server configured for being communicably coupled to a plurality of users' client computers. The server includes a social network module configured to store electronic user files for each of the users, and to generate a network user interface configured to enable communication among the users via the users' client computers in at least one of real time and asynchronously. The server also includes a forum module configured to store and display on a forum user interface, selected media including selections of the communication among the users, for access at the client computers. A virtual auction module is configured to generate an auction user interface by which users are able to generate proposals for desired financial research products or services, view the proposals, bid on the proposals, and collaborate on the proposals, in at least one of real-time and asynchronously. A payment module is configured to process payments between the users. A dashboard module is configured to generate an electronic dashboard configured to track and selectively display status of the electronic user files, including enabling users to selectively access the social network, forum and virtual auction modules in real-time.

In another aspect of the invention, a computer implemented method in a client-server environment, is provided for conducting and disseminating financial research products and services among users in an investment community. The method includes, with a server computer, storing electronic user files for each of the users, and generating a network user interface configured to enable communication among the users via the users' client computers in at least one of real time and asynchronously. The method also includes storing and displaying on a forum user interface, selected media including selections of the communication among the users, for access at the client computers. An auction user interface is also generated, by which users are able to generate proposals for desired financial research products or services, view the proposals, bid on the proposals, and collaborate on the proposals, in at least one of real-time and asynchronously. Payments between the users are processed, and an electronic dashboard configured to track and selectively display status of the electronic user files, enables users to selectively access the social network, forum and virtual auction modules in real-time.

In yet another aspect, an article of manufacture is provided for conducting and disseminating financial research products and services among users in an investment community. The article of manufacture includes a non-transitory computer usable medium having a computer readable program code embodied therein. The computer usable medium has computer readable program code for implementing the preceding aspect of the invention.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one aspect of a network-based transaction facility usable with various aspects of the present invention;

FIG. 2 is a block diagram of an aspect of a database maintained by a database engine server of the facility of FIG. 1;

FIG. 3 is a diagrammatic representation of one aspect of a user table within the database of FIG. 2;

FIG. 4 is a simplified block diagram of one aspect of a system employing aspects of the present invention;

FIGS. 5A-5B are block diagrams of interface sequences implementing various aspects of aspects of the present invention;

FIGS. 6A-6B are exemplary representations of various interfaces included in the sequence of interfaces shown in FIGS. 5A-5B;

FIG. 7A is a view similar to those of FIGS. 5A-5B, pertaining to additional aspects of the present invention;

FIGS. 7A-7C are views similar to those of FIGS. 6A-6B, pertaining to the aspect of FIG. 7A;

FIG. 8 is a flow chart of one aspect of a method in accordance with the present invention;

FIGS. 9-15B are exemplary displays of user interfaces in accordance with the flow chart of FIG. 8;

FIG. 16 is a view similar to that of FIG. 8, for another aspect of the present invention;

FIGS. 17-19C are views similar to those of FIGS. 9-15B, in accordance with the flow chart of FIG. 16;

FIG. 20 is a view similar to those of FIGS. 8 and 16;

FIGS. 21-24 are views similar to those of FIGS. 9-15B and 17-19C, in accordance with the flow chart of FIG. 20; and

FIG. 25 is a block diagram of one aspect of a computer system usable with various aspects of the present invention.

### DETAILED DESCRIPTION

In the following detailed description, reference is made to the accompanying drawings that form a part hereof, and in which is shown by way of illustration, specific aspects in which the invention may be practiced. These aspects are described in sufficient detail to enable those skilled in the art to practice the invention, and it is to be understood that other aspects may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

A method and apparatus for conducting and disseminating financial research and related services in a network-based transaction facility are described. In the following description, for purposes of explanation, numerous specific details are set forth in order to provide a thorough understanding of the present invention. It will be evident, however, to one skilled in the art that the present invention may be practiced without these specific details.

### Terminology

For the purposes of the present specification, the term “transaction” shall be taken to include any communications between two or more entities and shall be construed to include, but not be limited to, commercial transactions including purchase and sale transactions, auctions, event registrations, online collaborations, and the like, regardless of whether or not monetary consideration is involved.

As used herein, the term “user” refers to any individual accessing or otherwise logging into the system(s) shown and described herein. As described in greater detail hereinbelow, it is noted that users may login either individually or using enterprise (e.g., corporate) logins. For ease of explication, the following description will use the term “user” when the description is applicable to both individual and enterprise logins, while the terms “member” and “individual user” will be used when necessary to refer solely to enterprise or individual logins.

The terms “computer”, “end-user device”, and/or “user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine”, and the like are intended to refer to a computer-related component, including hardware, software, and/or software in execution. For example, a server may be, but is not limited to being, a process running on a processor, a processor including an object, an executable, a thread of execution, a program, and a computer. Moreover, the various components may be localized on one computer and/or distributed between two or more computers. The term “module” is intended to refer to a computer-related entity, either hardware, a combination of hardware and software, software, or software in execution. For example, a module may be, but is not limited to being, a process running on a processor, a processor, an object, an executable, a thread of execution, a program, and a computer. By way of illustration, both an application running on a server and the server (or control related devices) can be modules. One or more modules may reside within a process and/or thread of execution and a module may be localized on one computer and/or distributed between two or more computers or control devices. The term “real time” refers to sensing and responding to external events nearly simultaneously (e.g., within milliseconds or microseconds) with their occurrence, or without intentional delay, given the processing limitations of the system and the time required to accurately measure the data.

### Programming Languages

The system and method embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

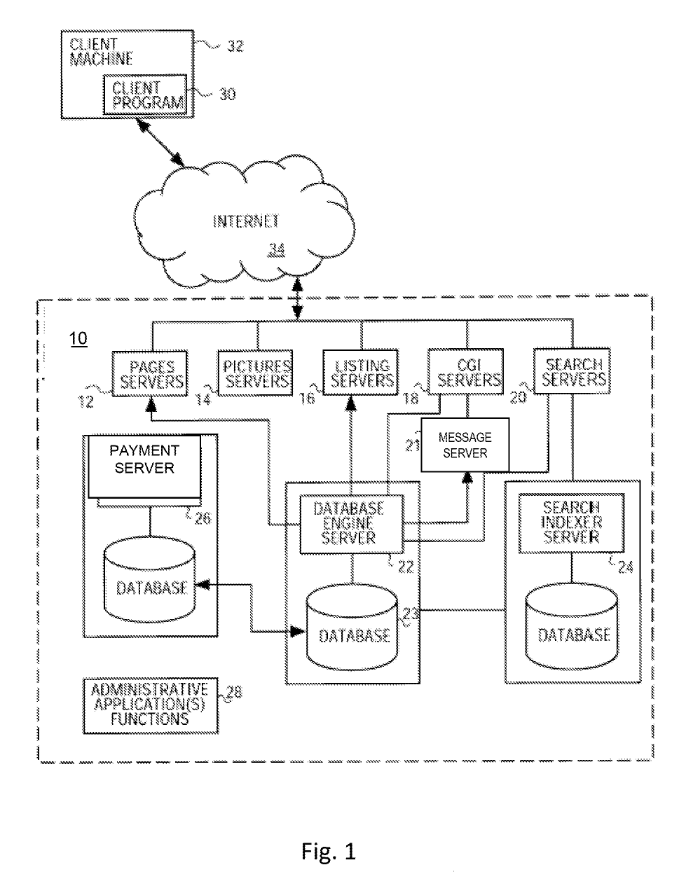

In particular aspects, the various transactions and transfers described herein may take place using the systems and components shown in FIG. 1, although one of skill in the art will appreciate that many variations of the system may be implemented without departing from the scope of the invention. Suitable networking protocols may be used, including the Transport Control Protocol/Internet Protocol (TCP/IP) suite of protocols, and also including the HyperText Transport Protocol (HTTP) and associated security protocols HTTPS, and other mechanisms such as Virtual Private Networking (VPN), Secure Sockets Layer (SSL), Transport Layer Security (TLS), tunneling protocols such as Generic Routing and Encapsulation (GRE), Layer 2 Tunneling Protocol (L2TP), and the like. In addition, some of the transactions may be communicated in a manual fashion, such as via telephone or textual messaging (email, and the like), whereupon the relevant transaction information may be entered into the appropriate computer systems.

Referring now to FIGS. 1-25, aspects of the present invention will be more thoroughly described.

Transaction Facility

FIG. 1 is a block diagram illustrating an exemplary network-based transaction facility in the form of an Internet-based financial network platform facility 10. The financial network platform facility 10 includes one or more of a number of types of front-end servers, namely page servers 12 that deliver web pages (e.g., markup language reports), picture servers 14 that dynamically deliver images to be displayed within Web pages, proposal listing servers 16 that deliver listings of proposals submitted by users of the facility, CGI (Common Gateway Interface) servers 18 that provide an intelligent interface to the back-end of facility 10, and search servers 20 that handle search requests to the facility 10. Messaging servers 21 provide, inter alia, automated communications (e.g., Instant Message, e-mail, etc.) to users of the facility 10. The back-end servers may include a database engine server 22, a search index server 24 and a payment (e.g., credit card and/or subscription, etc.) database server 26, each of which may maintain and facilitate access to a respective database. Facility 10 may also include an administrative application server 28 configured to provide various administrative functions such as access authorization and accounting (AAA) by accessing users' identification information, password files, encryption keys, etc. In this regard, server 28 may optionally include a AAA server and a security gateway (not shown).

The network-based financial network platform facility 10 may be accessed by a client program 30, such as a browser (e.g., the Internet Explorer distributed by Microsoft) that executes on a client machine (e.g., computer or other end-user device) 32 and accesses the facility 10 via a network such as, for example, the Internet 34. Other examples of networks that a client may utilize to access the financial network platform facility 10 include a wide area network (WAN), a local area network (LAN), a wireless network (e.g., a cellular network), or a private network including leased lines, or a virtual private network using virtual private network (VPN) protocols.

Database Structure

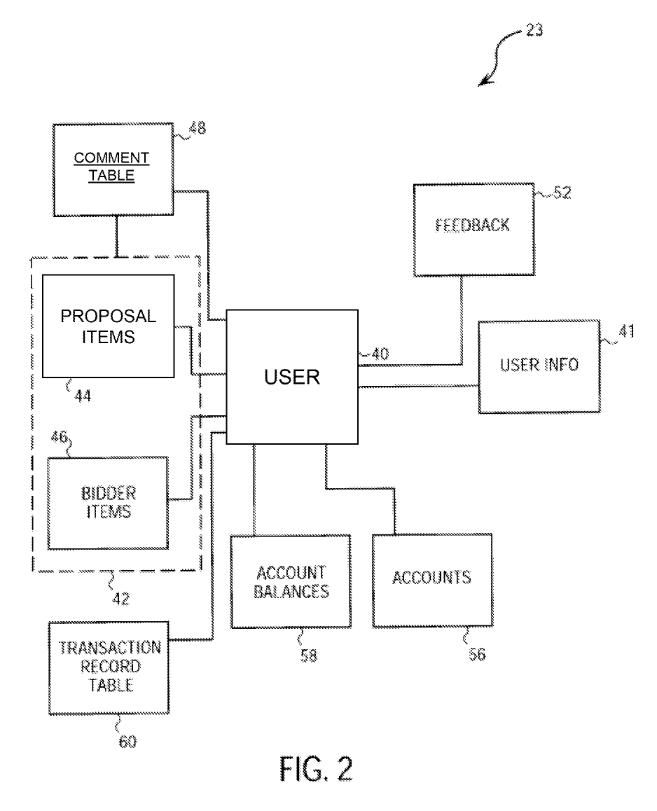

FIG. 2 is a database diagram illustrating an exemplary database 23, maintained by and accessed via the database engine server 22, which at least partially implements and supports the financial network platform facility 10. The database 23 may, in one aspect, be implemented as a relational database, and includes a number of tables having entries, or records, that are linked by indices and keys. In an alternative aspect, the database 23 may be implemented as collection of objects in an object-oriented database.

As shown, central to the database 23 is a user (member) table 40, which contains a record for each user of the financial network platform facility 10. A user may operate as a seller/provider of information, a purchaser of information, or both, within the facility 10. A user information table 41 is linked to the user table 40 and includes more detailed information about each user. The database 23 also includes item tables 42 that may be linked to the user table 40. Specifically, the tables 42 may include a proposal items table 44 and a bidder items table 46. A user record in the user table 40 may be linked to multiple items that are being, or have been, auctioned via the facility 10. A link may indicate whether the user is a proposer (buyer) or a bidder (seller) with respect to items for which records exist within the item tables 42. The database 23 also includes a note table 48 populated with note records that may be linked to one or more item records within the item tables 42 and/or to one or more user records within the user table 40. Each note record within the table 48 may include, inter alia, a comment, description, history or other information pertaining to an item being auctioned via the auction facility 10, or to a user of the auction facility 10, such as provided by the users as discussed in greater detail hereinbelow. A number of other tables may also be linked to the user table 40, such as a user feedback table 52, an accounts table 56 to track any accounts (e.g., both individual and corporate) for which the user is associated, an account balances table 58 and a transaction record table 60.

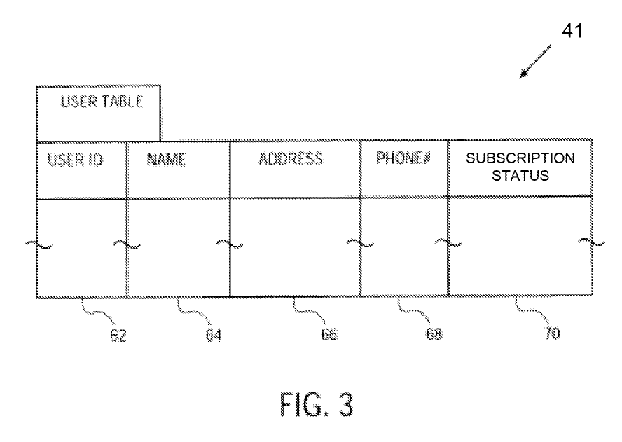

FIG. 3 is a diagrammatic representation of an exemplary aspect of the user information table 41 that is populated with records, or entries, for each user of the financial network platform facility 10. As shown, table 40 includes a user identifier column 62 that stores a unique identifier for each user. A name column 64 may store a first name, a middle initial and a last name for each user. An address column 66 may store full address information and/or other contact information for each user, e.g. a street name and number, city, zip code, state, email address, etc. A phone number column 68 stores a home phone number for each user. A subscription status column 70 may store, for each user, a value identifying the user's subscription status. That is, different values may be assigned to indicate whether a user has a currently valid subscription, has an expired subscription (and which may provide only limited access to facility 10), and/or is accessing the facility on a pay-as-you-go basis such as via credit card, etc. It will be appreciated that any information other than that described above may populate the user table 41 without loss of generality. The skilled artisan will recognize that a similar approach may be used to store data associated with any of the other tables shown and described in FIG. 2.

Financial Information Proposal and Bid Generation Process

As mentioned hereinabove, aspects of the present invention provide an automated system and method for generating bids for proposals for various types of finance-related goods and services. These aspects enable such activities to be occur in a real-time and/or asynchronous, web-based, client-server environment. Users may access these aspects on a subscription basis, a pay-as-you-go basis, or a combination thereof. While the present invention is discussed within the environment of the exemplary financial network platform facility 10, it will readily be appreciated that the present invention may be used in any number of environments including network and on-line based transaction facilities in business-to-business, business-to-consumer and consumer-to-consumer applications. Moreover, while these aspects are shown and described in a client-server environment, it should be recognized that a peer-to-peer environment may be used for various aspects of the aspects shown and described herein, without departing from the scope of the present invention.

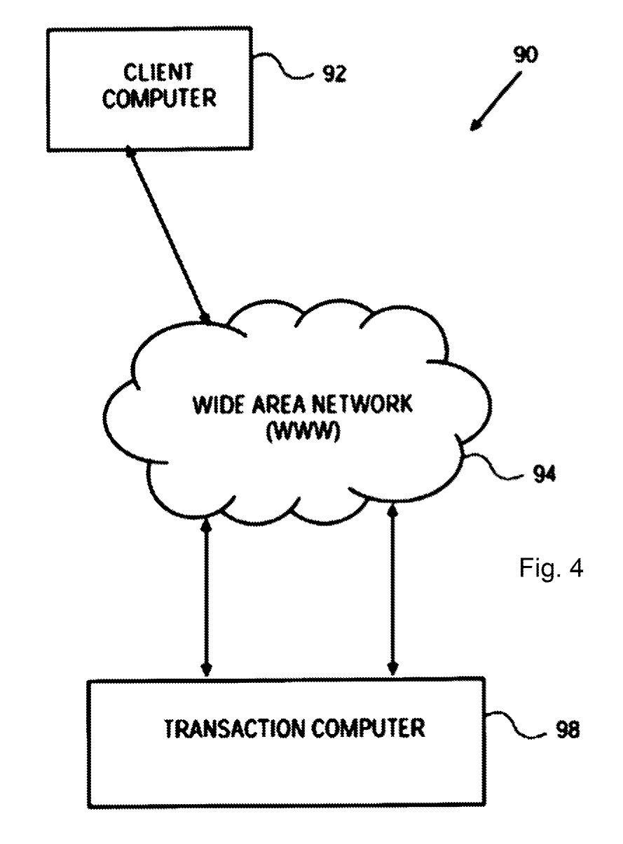

FIG. 4 is a simplified block diagram of a system 90 for generating and disseminating financial information in accordance with an exemplary aspect of the present invention. In this aspect, a client computer 92 is coupled to a transaction computer 98 via a communications network (e.g. a wide area network) 94. The client computer 92 represents a device that allows a user to interact with the financial network platform facility 10 or any other transaction facility 98. In one aspect, the client computer 92 presents to the user a graphical user interface for searching, uploading and downloading content, and communicating with other users associated with the transaction computer 98.

The transaction computer 98, which supports a financial network platform facility such as facility 10 of FIG. 1, handles transactions between various participants of the facility 10 including the user of the client computer 92. In one aspect, the transaction computer 98 may initially receive the personal information of the participant from the client computer 92, and generate a subscription result which determines whether, and to what extent, the user is granted access to the facility 10. The transaction computer then facilitates the various interactions described herein, including proposal generation and bidding thereon, in accordance with various user interfaces presented by the computer 98, via the client computer 92, to the user.

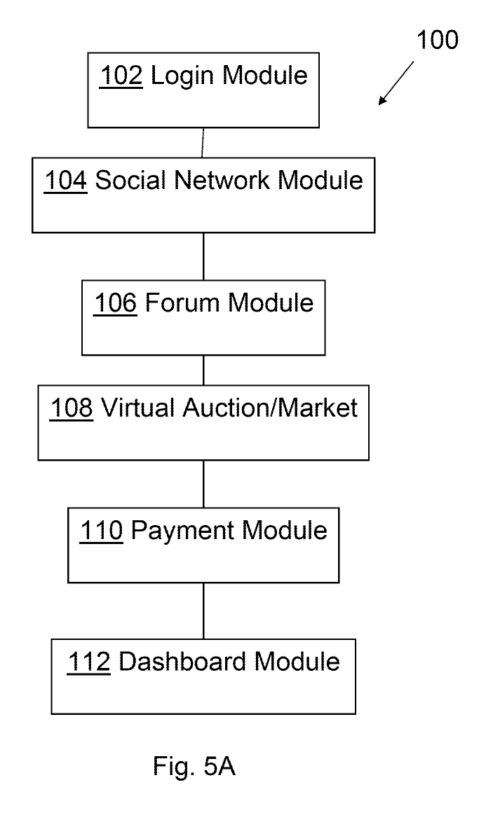

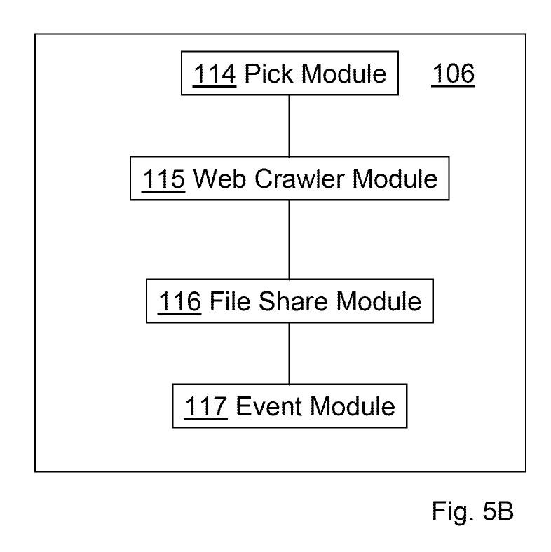

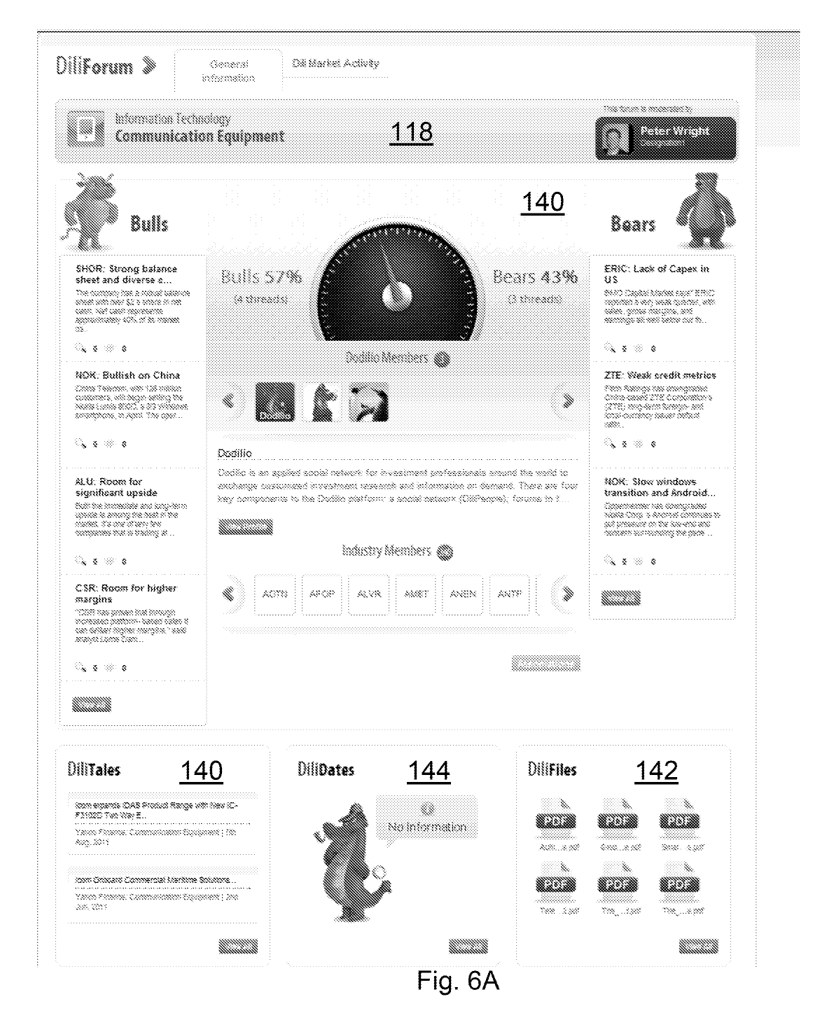

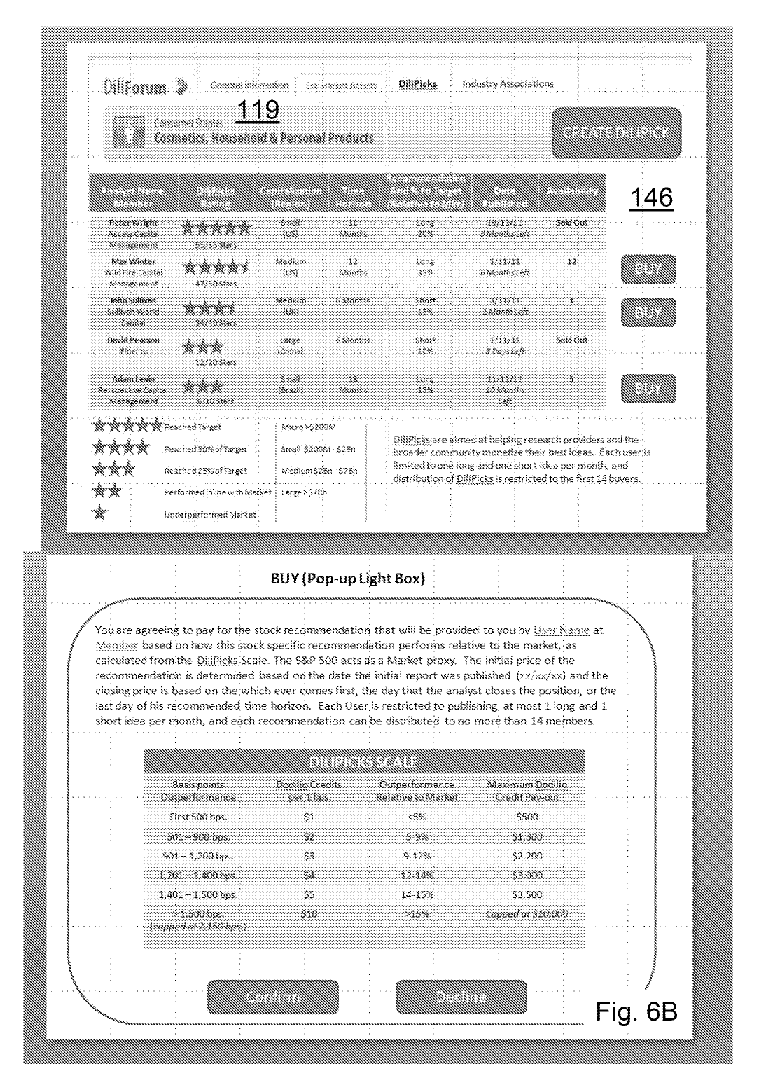

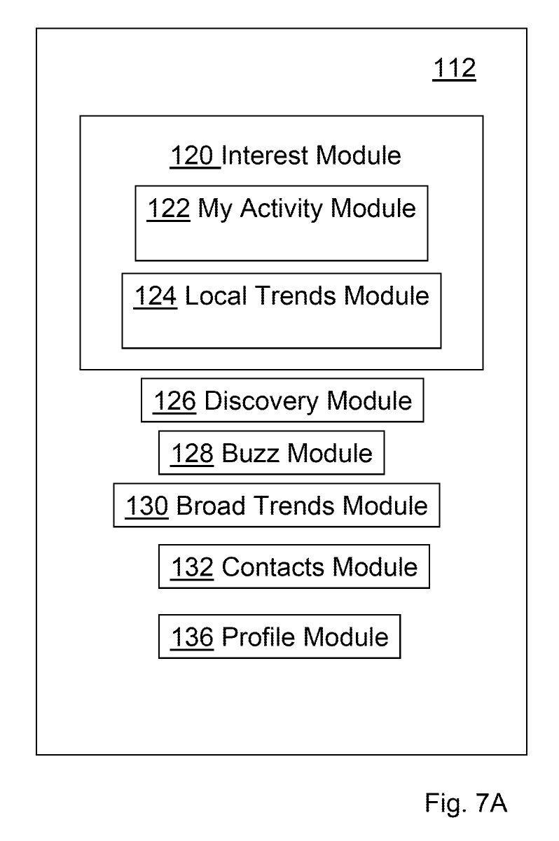

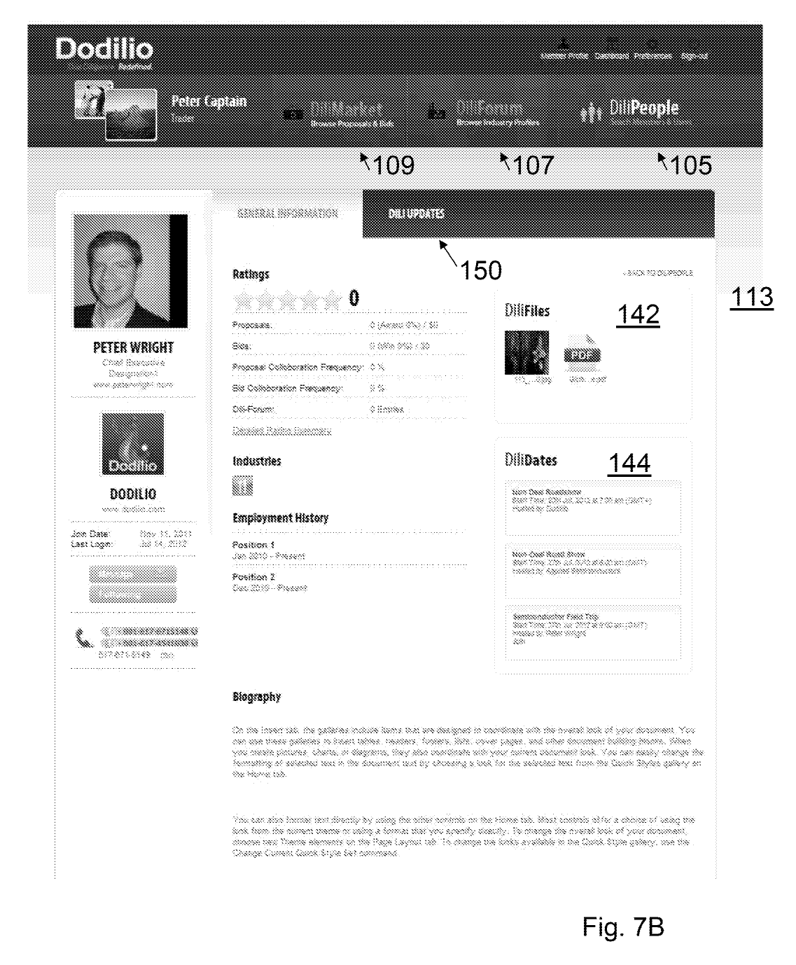

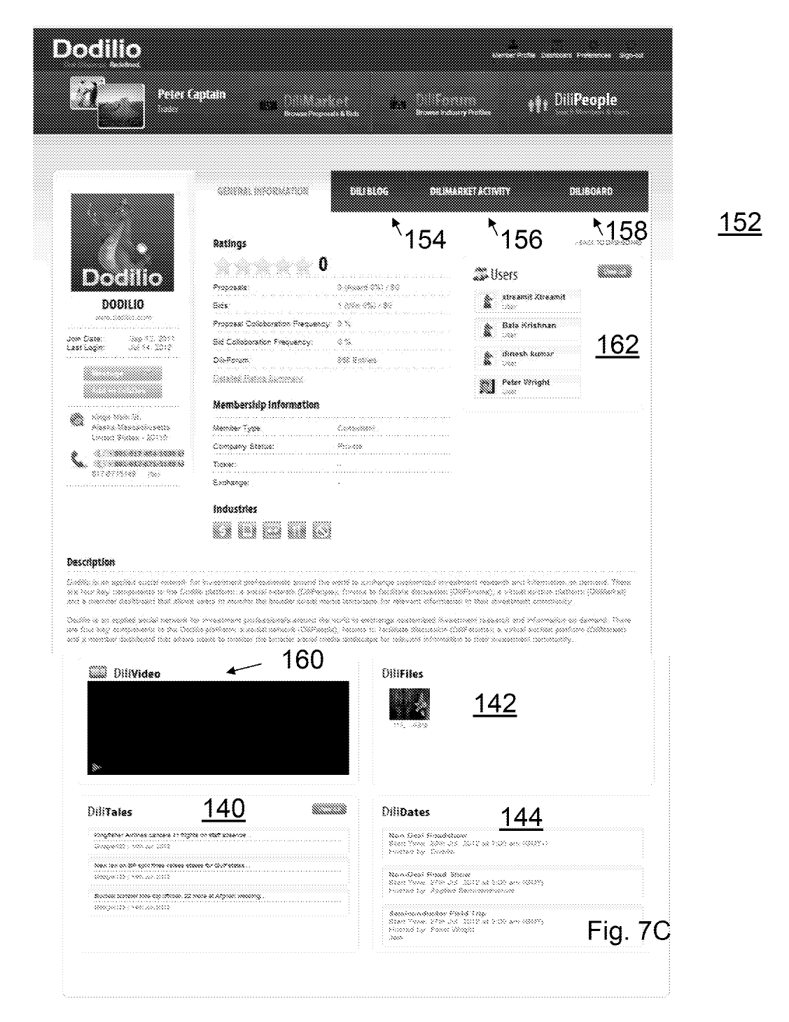

FIG. 5A shows a series 100 of modules, such as may take the form of a series of objects (or methods), that may be implemented by the financial network platform facility 10, e.g., in combination with the various tables of database 23, for the purposes of providing the various functions described herein. The series 100 of modules shown in FIGS. 5A, as well as those of FIGS. 5B and 7A, will be described with reference to exemplary representations of the various interfaces shown in FIGS. 6A, 6B, 9-15C, 17-19C, and 21-24.

As shown, series 100 includes a login module 102, configured to generate a login interface through which a user of the facility 10 provides at least a user identifier and associated password. As mentioned hereinabove, the user may be requested to pay a fee to gain access, such as through a subscription or pay-as-you-go process. A social network module 104 is configured to store electronic user files for each of the users, and to communicably couple a plurality of users' client computers to one another, to enable communication and collaboration among the users both in real time and asynchronously, in the creation of custom research, etc. A forum module 106 is configured to store and display selected media including communications by and among the users, for access at the client computers. A virtual auction platform (VAP) module 108 is configured to enable the users to submit proposals, to submit bids on the proposals, and collaborate with other users on either the proposals or bids. The VAP 108, along with modules 104 and 106, may thus form the basis of an applied social network, whose users share a common goal, which may be to share information and to facilitate collaborative learning among users. The common goals may be based on the fact that sharing information enables achieving better results.

In particular aspects, the VAP 108 is configured to implement reverse auctions, in which users may publish proposals, e.g., written and/or audio visual descriptions, of desired products or services. Other users who have the ability to provide some or all of the subject matter of the proposals, may then view and submit bids, either alone or in collaboration with other bidders, to provide the requested products or services. This bidding and/or collaboration may take place in real-time or asynchronously via system 10. A payment (subscription) module 110 may be configured to track payments between the users and/or with the host of the facility 10. A dashboard module 112 is configured to generate an electronic dashboard to help users navigate the site, understand users' usage trends, and gauge other users' interest in the user or member, etc.

Aspects of the present invention thus provide a next generation social network that facilitates connectivity, communication and collaboration among investment community professionals. These aspects provide a holistic approach to the investment research process from a user standpoint, in which independent users may be provided with access to investment research information, and with ways of generating, disseminating and consuming investment research information, which would not have been available to that user absent the collaborative and customizable aspects of the present invention. The investment research information may take forms such as surveys, reports, presentations, models, blogs, wikis and chats/video conferences, among other forms.

In accordance with one aspect, upon logging in to the system, a user may access a dashboard presented by module 112, to navigate between the social network interface 104, forum(s) 106, and VAP 108. For example, the functionalities of modules 104, 106 and 108 may be conveniently accessed by selecting tabs/thumbnails 105, 107 and 109, respectively, as shown in interface screen 113 of FIG. 7B, which will be discussed in greater detail hereinbelow. And as mentioned above, the skilled artisan will recognize that secure transmissions and/or encryption of data may be used to ensure secure communications/transactions among users of system 10.

Turning now to FIG. 5B, as mentioned above, a forum module 106 may be used to facilitate sharing of ideas among those in the financial community. In particular aspects, this module 106 may include a pick module 114 a web crawler module 115, a file share module 116, and an event module 118. The pick module 114 provides a place where users can pitch ideas, such as stock picks, to the community, and get paid based on accuracy. Web crawler module 115 implements an otherwise conventional web crawler configured to track industry specific news from various sources, including selected RSS feeds. File share module 116 provides cloud-based (e.g., remote, internet based) file storage to which content such as industry specific files may be uploaded and shared with other users. The cloud based file share module 116 thus provides a central repository for shared files, to avoid version control issues by helping to ensure that all users are accessing the same version of the shared files. Substantially any content generated and/or shared via facility 10 may be stored in the central repository of module 116, to help ensure that all users accessing the content are accessing the same version, etc. Event module 117 stores and displays events and/or dates for events that industry related users are attending (e.g., based on sign ups) and/or hosting, via system 10.

Forum module 106, may thus use one or more of modules 114-117 e.g., in combination with the user communication provisions of message server 21 (FIG. 1), to create and populate any number of online forums dedicated to various of interest to users of the facility 10. In particular aspects, each forum may represent a specific industry and/or research sector, such as commodities and non-equity asset classes, among other research sectors.

In some aspects, independent moderator(s) may assist with the elimination of information redundancy and noise, and help bring the most important information to the fore. These forum(s) may thus be the platform through which news can be shared between enterprises and the investment community. Examples of user interface screens displayed by forum module 106 include the general information page of a Communication Equipment forum 118 of FIG. 6A, which includes displays/thumbnails 140, 142 and 144 generated by modules 115, 116, and 117, respectively. A representative pick display 146, as generated by pick module 114, is shown in FIG. 6B. In the example shown, pick display 146 is provided within a forum 119 for cosmetics, household and personal products. As shown, screen 146 may include a list of users offering their picks (recommendations), with supporting information such as their ratings as provided by other users, and various high level, but incomplete, information about the particular (e.g., stock) pick. Screen 146 may also include a payment screen 148 by which a user may agree to make a payment in exchange for receiving the complete information, e.g., including the identity of the particular stock being recommended.

Turning now to FIG. 7A, an exemplary dashboard module 112 may include various sub-modules configured to provide functionality that may be accessed by tabs on a user interface. For example, dashboard module 112 may include an interest module 120 configured to present a gauge of other users' interest in a particular user, the interest being determined based on the other users' actions performed on the facility 10. In particular aspects, module 120 may include a my activity module 122 that captures the other users' activity with respect to any of the activity of the particular user. Examples of this may include information pertaining to bid activity on proposals submitted by the particular user. Module 120 may also include a local trends module 124 configured to capture and display trends based on other users' other activities that may be at least indirectly related or otherwise relevant to the user's interests.

A discovery module 126 is configured to capture and display conversations in the social landscape involving various user-selected keywords, while a buzz module 128 may capture and display conversations in which a particular company name is mentioned. A broad trends module 130 captures and provides an overview of a wide range of words and topics being discussed by others, e.g., within a particular user's list of contacts. This list of contacts may be stored and made accessible by contacts module 132. Dashboard module 112 may also include a profile module 136 configured to enable users to create and edit profiles that will be maintained and displayed to other users via facility 10.

It should be noted that substantially any of the other modules shown and described herein may be accessed by users via dashboard module 112. For example, dashboard module 112 may display a thumbnail such as 140, 142 and 144 (FIG. 6A) which a user may select to drill down into content provided by modules 115, 116 and 117 respectively. It should be noted that any of the various displays, including thumbnails included therein, may be provided with links that are selectable in a conventional manner to drill down to additional content and/or detail. It should also be noted that any of the various displays and thumbnails provided in the user interface screen of the any aspect hereof, may be included in any other interface screen, as may be desired for particular users or user application, without departing from the scope of the present invention.

As mentioned briefly hereinabove, in particular aspects, users may be provided with various privilege levels to access different functionalities provided by the system. These privileges may be determined, at least in part, by the user profiles (including user/login type) maintained by profile module 136. Each user profile may be displayed as one or more web pages dedicated to the particular user, which display basic information about the user, e.g., name, educational and employment history, and personal tastes, among other information.

As also mentioned above, particular aspects may provide for a multi-level or tiered membership, in which users may access the system via a corporate (enterprise) login or an individual login, each of which may be purchased separately. For example, in the event a corporate membership is purchased, an individual may access the system using a corporate login. Alternatively, the individual may login as an individual user, e.g., as an employee of the enterprise/corporate member, and/or under a separately purchased individual membership. And companies or other enterprises are generally referred to as “members”, while individuals are generally referred to as “users”, though for convenience, unless otherwise noted, the term “user” is used in this Detailed Description to broadly refer to both individual and corporate (enterprise) logins.

The functionalities available to the user may vary, with some options being available at the enterprise level, others being available at the individual user level, and yet others being available at both the individual and enterprise levels. In particular aspects, users may include, among others, institutional investors, sell-side analysts, independent researchers, industry trade organizations, corporations, investment bankers, private equity and venture capitalists, and regulators. Moreover, each user may be rated on the basis of their activity, number of proposals, number of bids, and frequency of collaboration, among other factors. The ratings may be made available as part of the user's profile information.

A representative example of an individual user profile page 113 generated by profile module 136 is shown in FIG. 7B. Page 113 may be accessed via a user dashboard, which as mentioned hereinabove, may include various tabs, such as tabs 105, 107 and 109. Any number of additional tabs/thumbnails may be provided, to access one or more of the various modules shown and described herein, e.g., depending on the privileges and/or preferences of the particular user. In the particular aspect shown, an updates tab 150 is provided to display a status feed of comments from users, such as employees of the same enterprise member, which may be provided by network module 104 (FIG. 5A). As also shown, in this aspect a files tab 142 and dates tab 144 may be provided to respectively provide convenient access to shared files, and to events that user is attending, has signed up for, and/or is hosting.

A representative example of an enterprise member profile page 152 generated by profile module 136 is shown in FIG. 7C. As shown, this page 152 may be accessed via a user dashboard such as shown and described in FIG. 7B, and may include various additional tabs to provide functionality tailored to corporate users. In the example shown, such additional tabs include a blog tab 154 for accessing a user blog enabled by module 136, a market activity tab 156 for accessing the member's activity via VAP module 108, a billboard tab 158 for accessing network module 104 to display comments at the member level and/or for seeking expert assistance with regard to a research request. A video display 160 may be provided to play an explanatory video of member's relevance to the community, while a contacts tab 162 may be included to access a member's contacts via contacts module 132 (FIG. 7A). Any number of other tabs may be provided, such as tales, files, and dates tabs 140, 142 and 144 as described hereinabove.

In particular aspects, the contacts module 132 may keep track of the user's other user-level contacts, members that the particular user is following, and other users who are following the particular member with which the particular user is associated (e.g., employed). In this regard, in particular aspects, permission must be obtained from a user before being added to another user's contact list. However, members may be followed without express permission.

Referring back to FIG. 5A, in particular aspects, Virtual Auction Platform (VAP) module 108 helps to increase the buying power of investors (and other users) while also providing an affordable solution for enabling users to collaborate in performing investment research. In accordance with one aspect, the VAP 108 provides an independent open market exchange that performs matching of buyers and sellers and facilitates open price discovery that, in turn, contributes to the affordability of the solution. In accordance with aspects of the present invention, members/users may collaborate on both sides of a proposal. For example, when making a proposal, collaboration may lead to cost sharing and may facilitate research that would otherwise be difficult, if not impossible, to coordinate. If a member wishes to purchase a research report costing $10,000, for example, collaboration with other members will likely lead to reducing the first member's costs. As another example, when bidding on a proposal, collaboration allows members to expand their geographic reach (e.g., collaboration between investors in the United States and China). Thus, collaboration may simultaneously enhance product quality and users' buying power.

In various aspects, examples of the types of research products that may be requested (e.g., proposed), and on which users may bid, include: virtual conferences—real-time meetings online by video conference or voice, or in-person, and/or asynchronous webinars to connect experts with investors; tours—physical tours for investors and research providers to meet with companies on site; data—traditional research products including reports, models, presentations, etc.; surveys—organized aggregation of opinions; and channel checks—organized aggregation of facts including research conducted across an industry or market that provides insights complementary to balance sheet analysis, such as distributor and retailer attitudes towards a product and its competitors, seasonal and geographic variation, inventory levels “channel stuffing”, etc). In particular aspects, particular events, both onsite and offsite, may also be proposed and bid on using VAP 108.

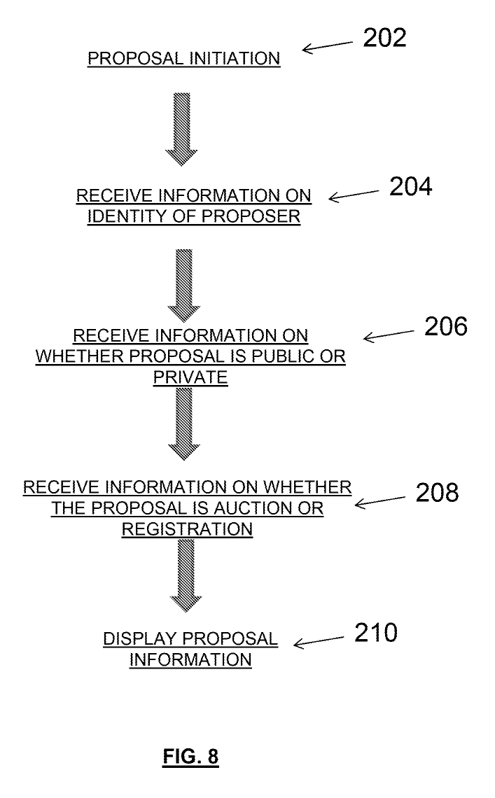

Turning now to FIG. 8, in accordance with particular aspects of the present invention, the proposal process may be initiated 202 by receiving information regarding the identity of the proposer at 204. In some variations, the proposer may remain anonymous, in which case only the winning bidder learns the identity of the proposer. At 206, the proposal may be designated public or private, e.g., in which a public proposal is made available to all members, while a private proposal is made available only to selected recipients and/or recipients having predetermined characteristics such as determined based on their profiles. At 208, the proposal may be designated as an auction or as a registration or invitation. A registration or invitation proposal is a fixed price offer, which may include a price of zero such as when a user is interested in collaborating without receiving payment or when simply registering for an existing event. An auction proposal may be made when the user is seeking remuneration for a price to be determined via auction format. At 210, the proposal information may be displayed to enable bidders to view, bid and join existing bids. It should be noted that the proposal process may include one or more additional steps as may be desirable in particular applications. For example, the process may include classifying the proposal in accordance with one or more of the proposal types discussed hereinabove (as a conference, tour, report, etc.), which may serve to help stream-line the proposal generation process and enhance the searchability of the proposals by other users (i.e., by potential bidders). The system may also prompt the proposal initiator to enter a desired level and type of compensation. For example, the proposal initiator may require payment in U.S. dollars, Euros, or other currency. Alternatively, or in addition, the facility 10 may permit and track compensation in the form of non-cash payments, such as a point system in which points are earned which add to a users' status or rating on the system, and which may or may not be redeemable for goods or services. In particular aspects, facility 10 may permit and track compensation in the form of credits for soft dollar accounts commonly used by Registered Investment Companies pursuant to Section 28(e) of the Securities Exchange Act of 1934 (commonly referred to as “28E soft dollar accounts”). Such soft dollar credits may be used, for example, by an investment manager to pay for research on behalf of the investment manager's client(s), which is provided by users of system 10.

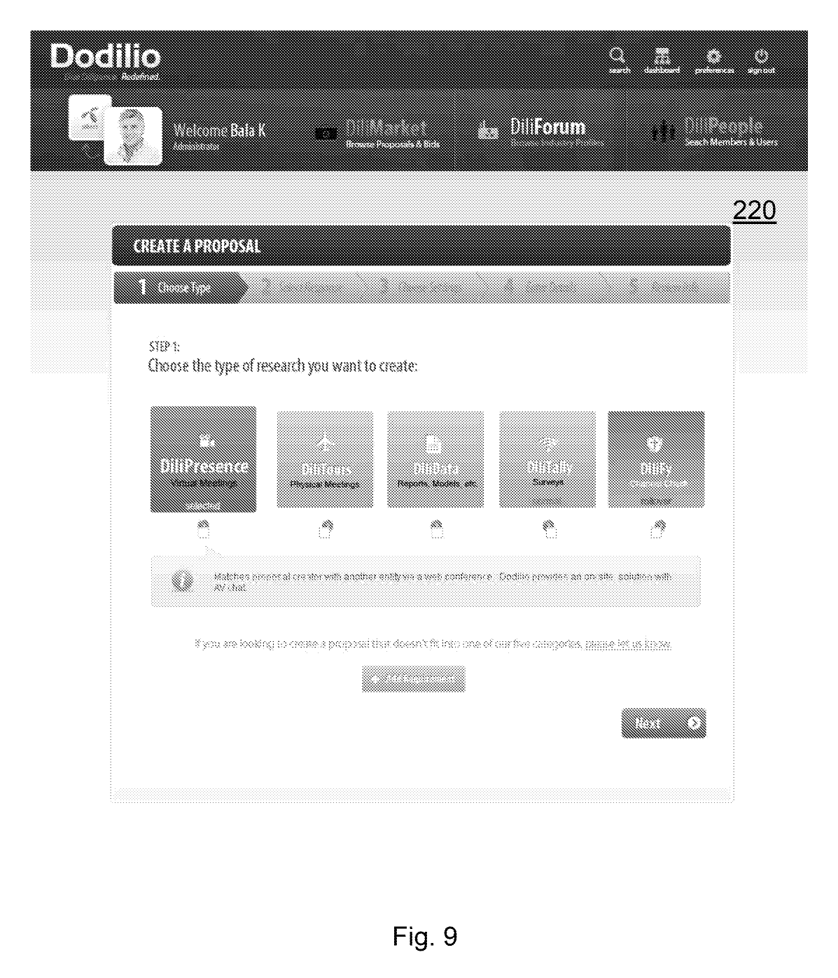

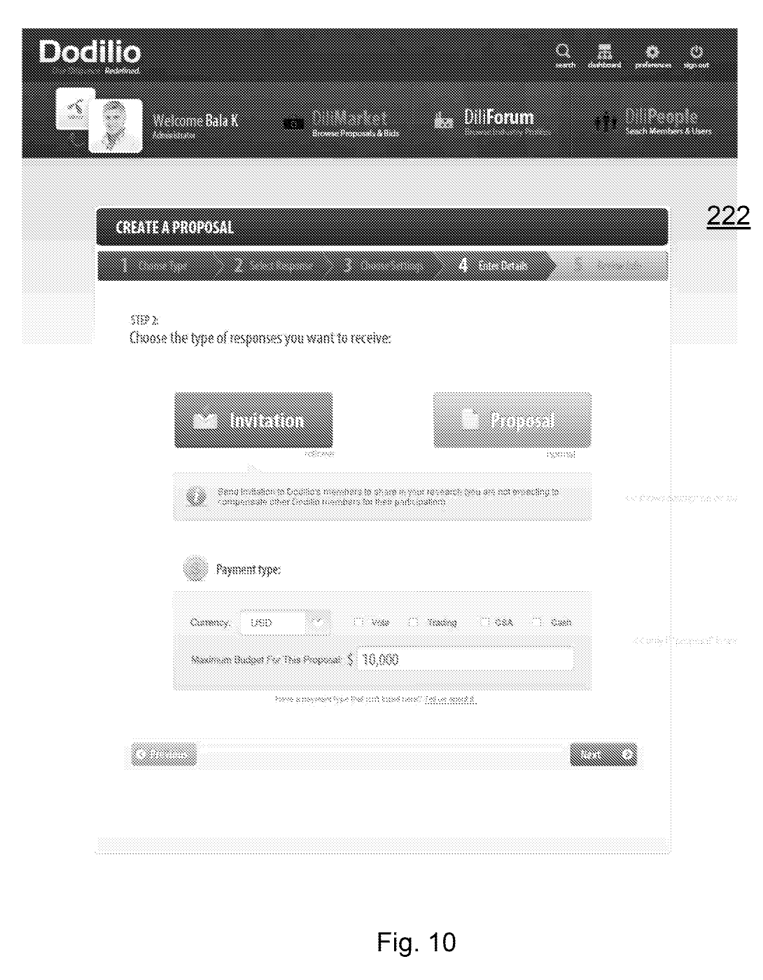

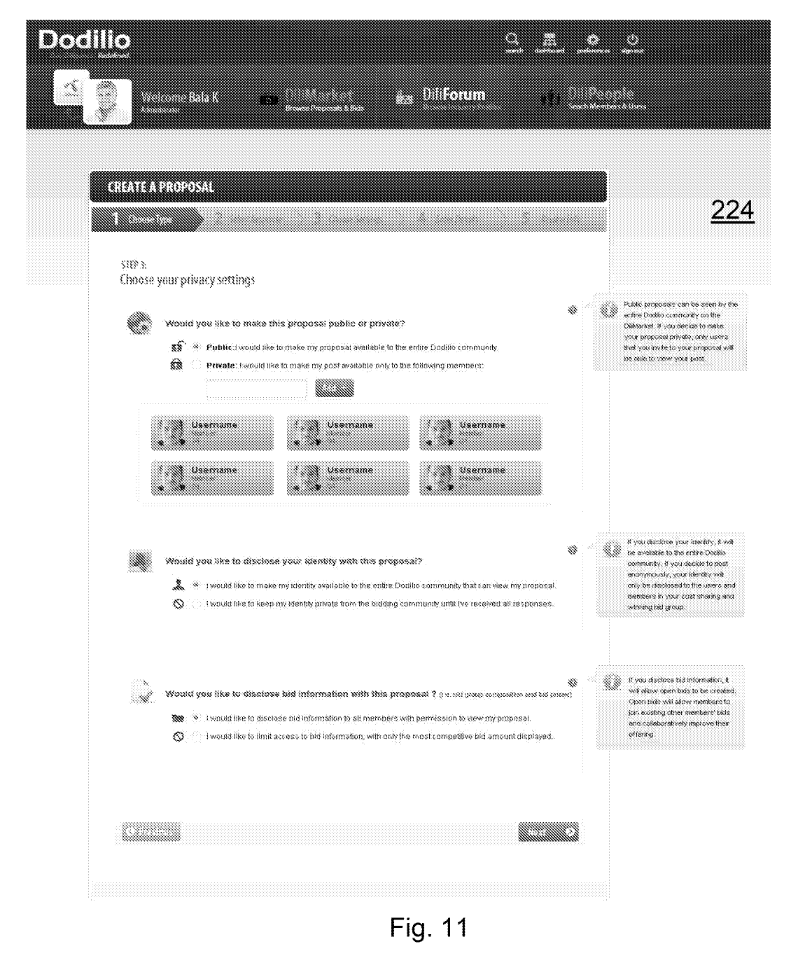

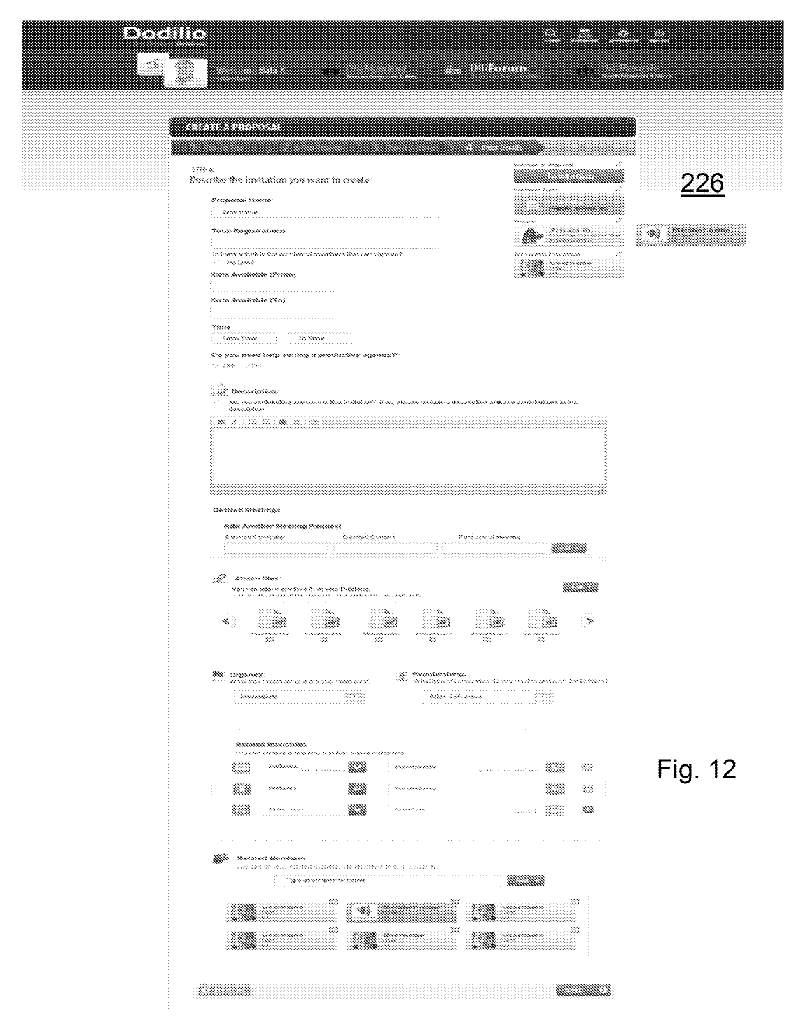

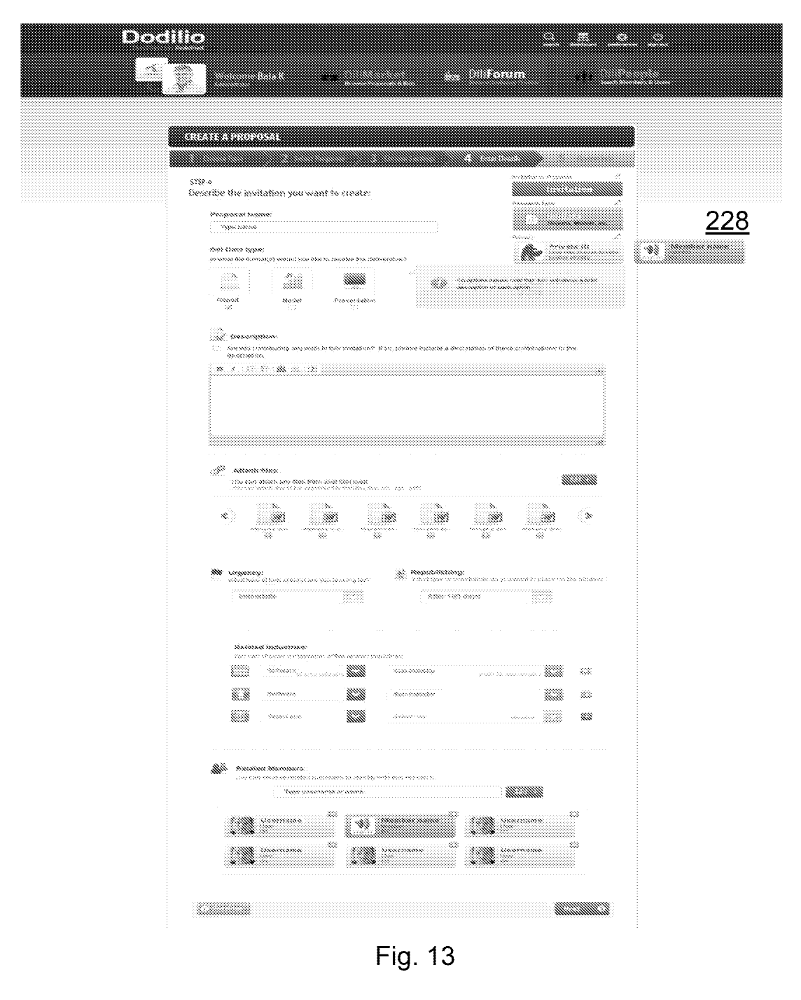

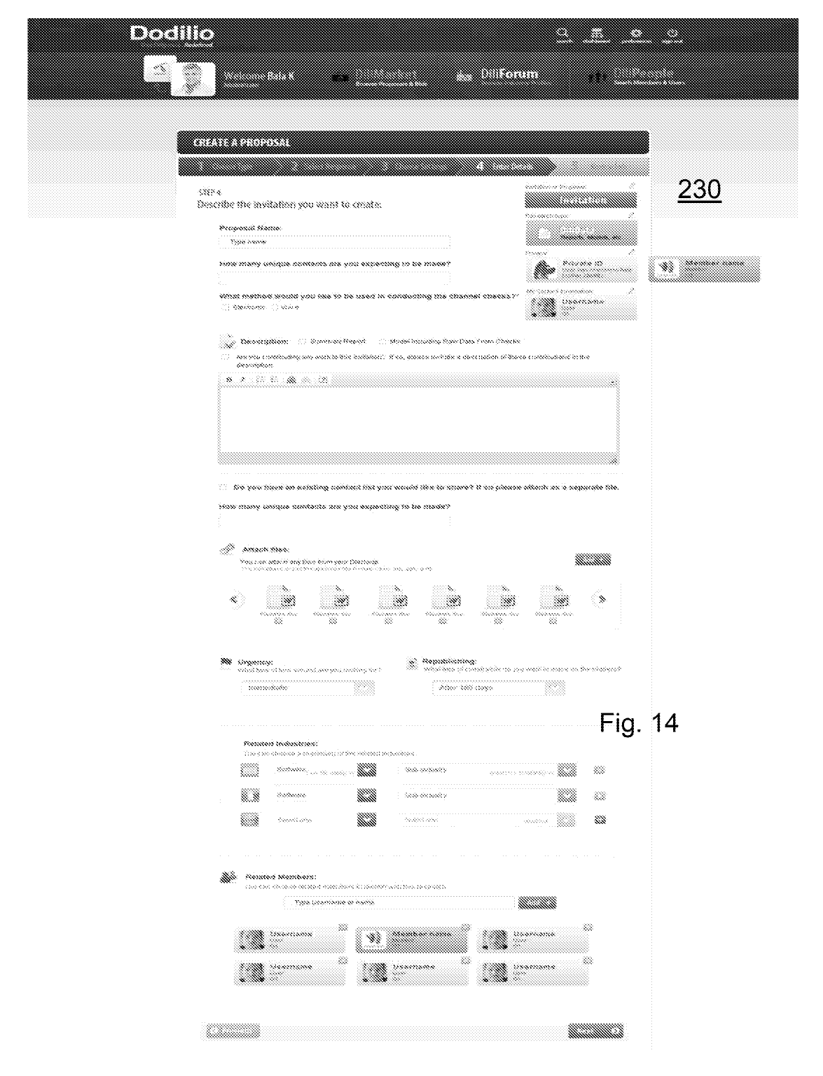

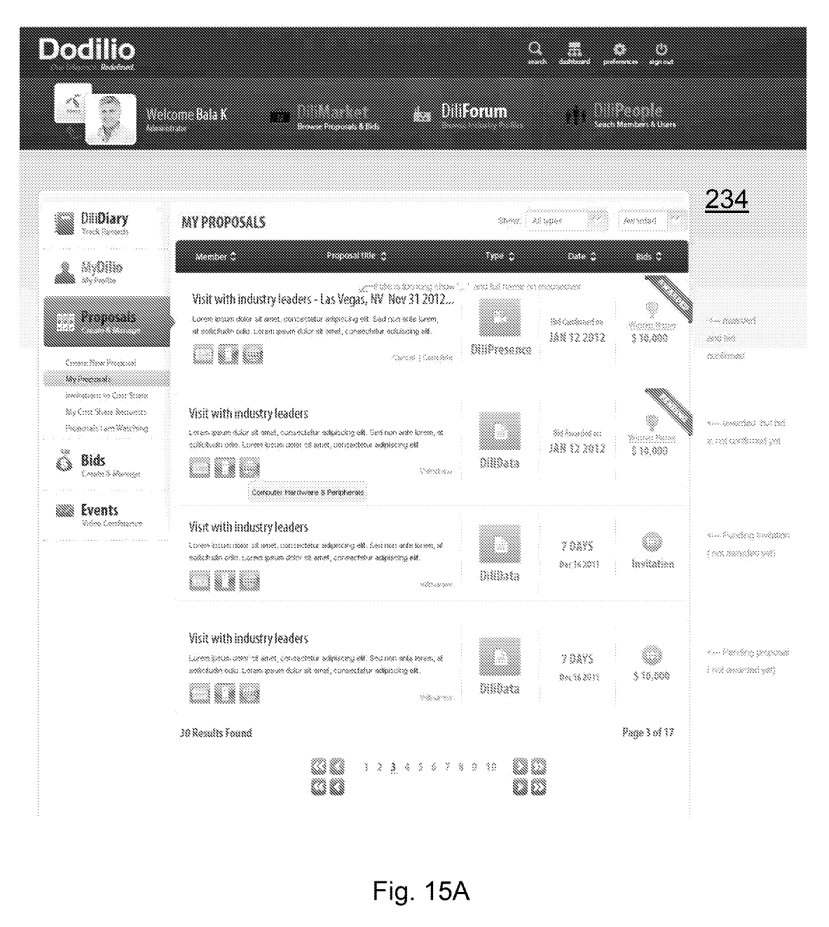

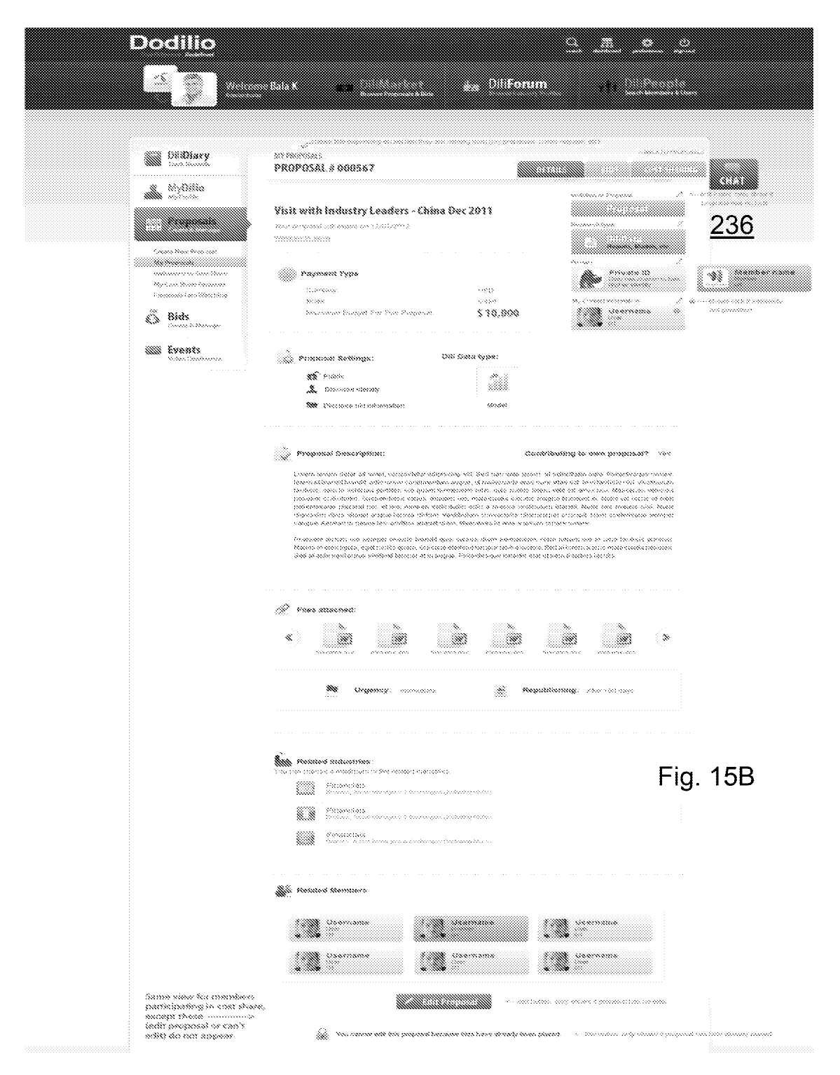

Representative examples of user interface screens generated by facility 10 to effect the proposal generation process are shown in FIGS. 9-15B. In the screen 220 of FIG. 9, a user may select the type of proposal. At screen 222 of FIG. 10, the user may select whether the proposal is for an auction (paid) or a registration/invitation (fixed fee including unpaid) per step 208. If the former, the user may indicate a desired payment type and anticipated budget as shown. The privacy settings of step 206 are set via screen 224 of at FIG. 11. The system may invite the user to enter additional information regarding the particular proposal at additional screens, such as for virtual meetings/tours at screen 226 of FIG. 12, products/data at screen 228 of FIG. 13, and channel checks at screen 230 of FIG. 14. The system may then enable the user to review and approve the proposal in a conventional manner, after which the proposal will be published to the site where it may be viewed by other users. It should be recognized that some aspects may provide various additional user interfaces, such as a My Proposal screen (FIG. 15A) in which a summary and/or thumbnail view of all the proposals created by a particular user may be displayed, e.g., accessed via dashboard module 112 (FIG. 5A). A user may then select any one of the summaries/thumbnails to present a detail view such as shown in FIG. 15B.

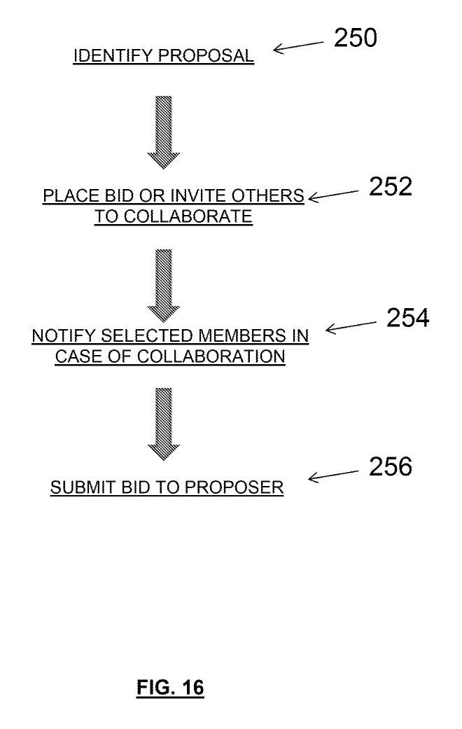

Turning now to FIG. 16, an exemplary bidding process is shown, as it may take place up until the point at which a bid is submitted to the proposer. In this particular aspect, the facility 10 enables a user to locate proposals of interest at 250, e.g., by using filtering criteria such as post date, user, industry, and type of product, to locate proposals of interest. Once a project of interest has been identified, a bidder may place a bid, or may invite others to collaborate at 252. A bidder may thus bid on a proposal individually, or can request the collaboration of others, in accordance with aspects of the present invention. Collaboration may be initiated through invitation, or publically via the VAP 108, e.g., in combination with network module 104 (FIG. 5A). If collaboration occurs, selected users may be notified, e.g., via message server 21 of facility 10 (FIG. 1), at 254. Selected users may be presented with an interface screen that outlines the terms of the bid, including each user's responsibilities and revenue share. In accordance with one aspect, when a change is made to the bid, all users must accept or reject the changes. When all users of the bid group accept the terms of the bid, it may be submitted to the proposer at 256.

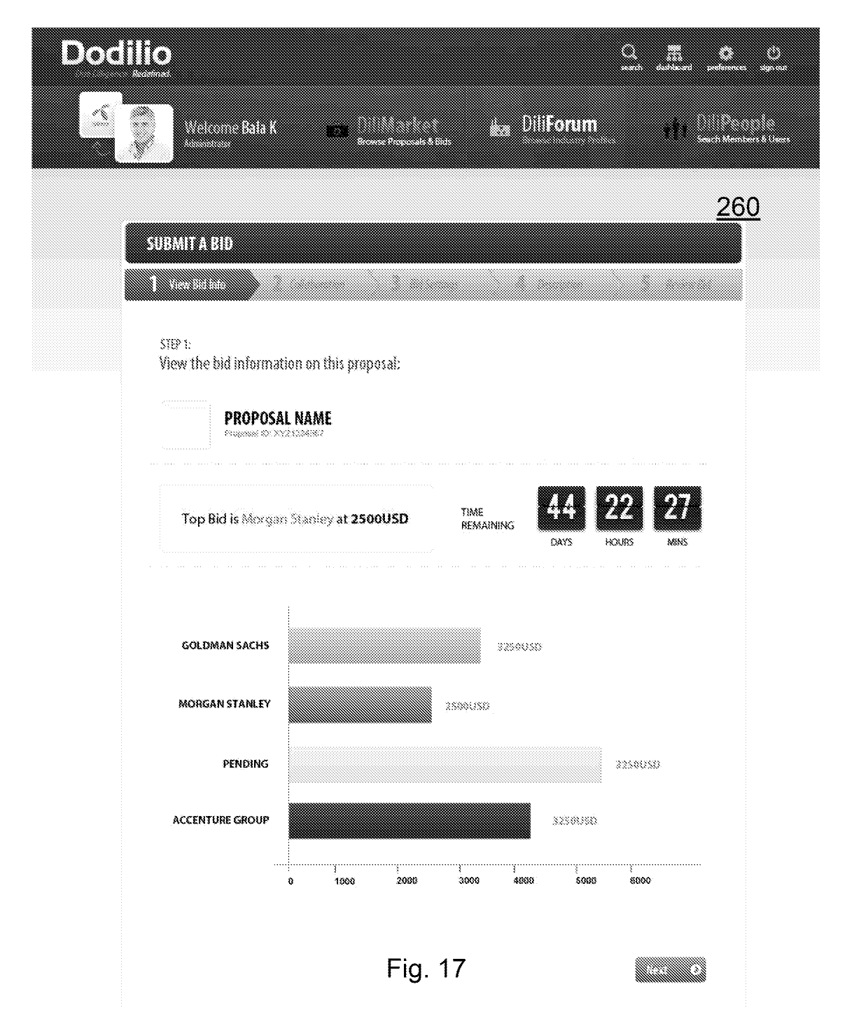

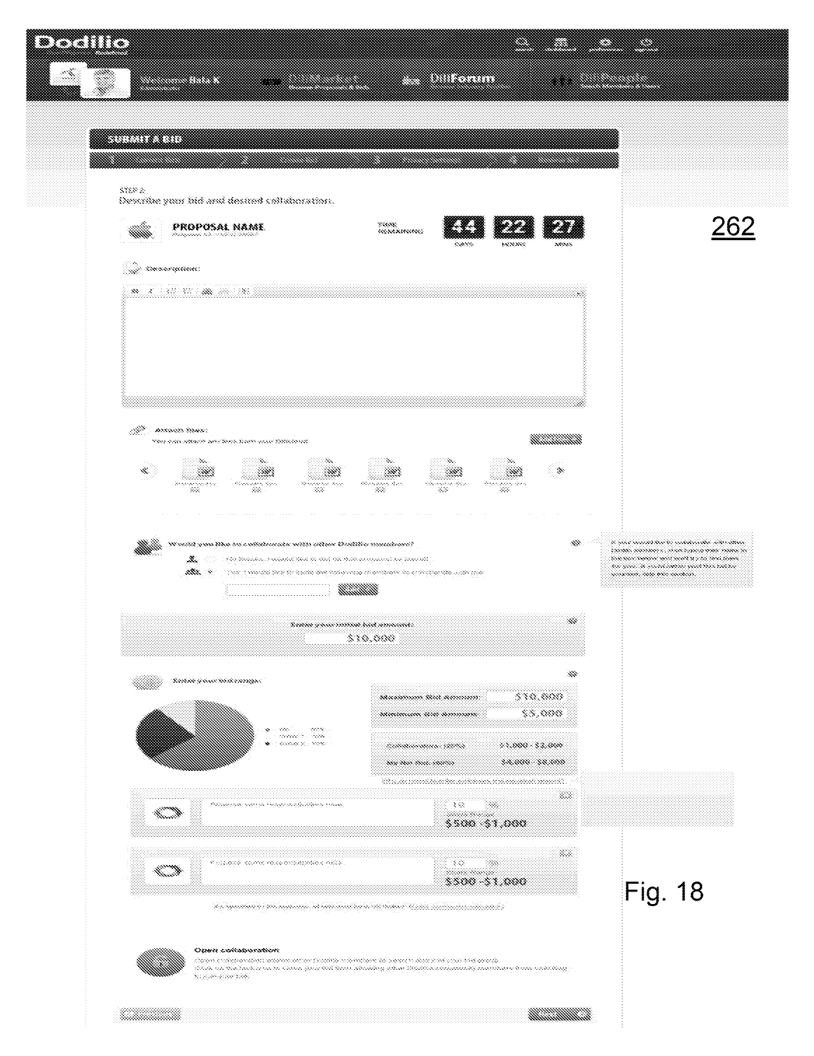

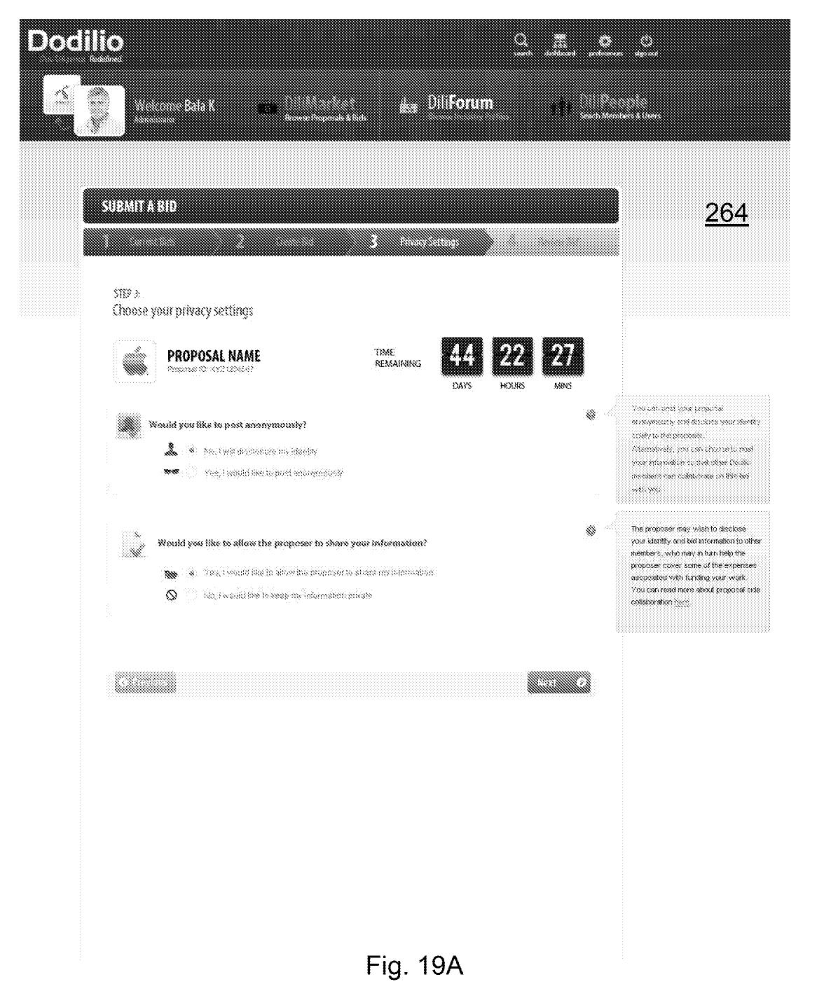

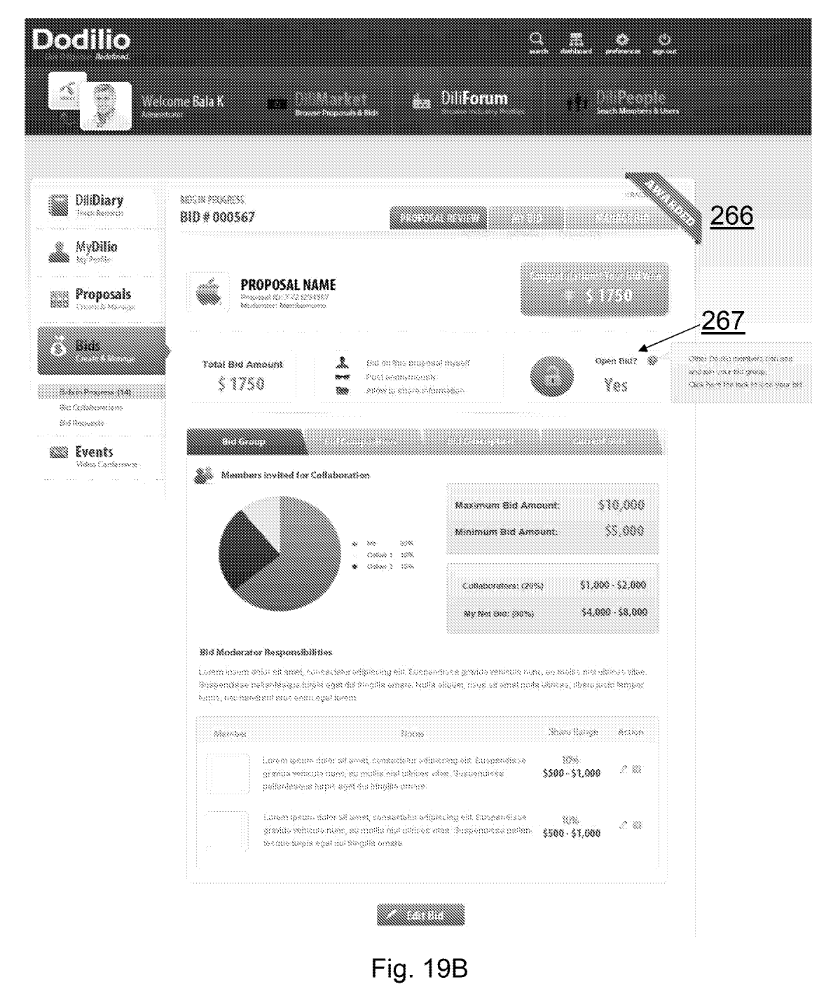

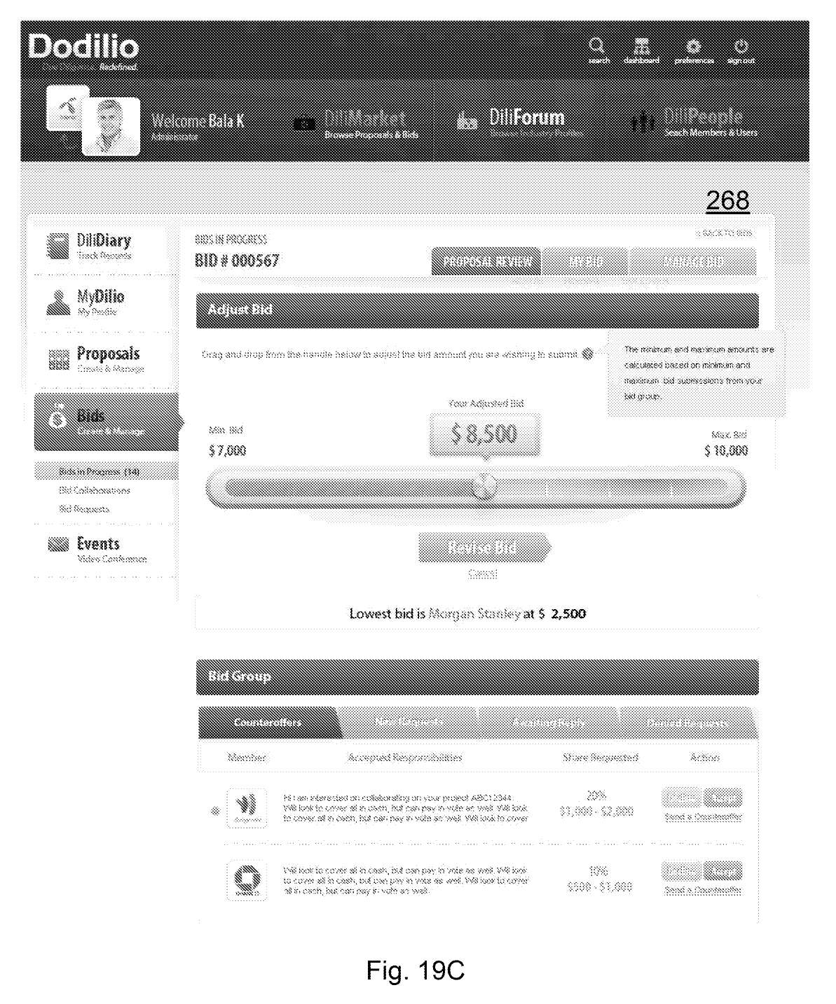

Representative examples of user interface screens generated by facility 10 to effect the bidding process are shown in FIGS. 17-19C. In the screen 260 of FIG. 17, a user may view a proposal identified at 250 of FIG. 16. In the particular example shown, aspects of the proposal such as the name of the proposal, the time remaining to bid, and the identities and amounts bid by other bidders are shown. It should be recognized, however, that some of this information, such as the identities and/or the current bid amounts, may be hidden from other bidders, depending on the selections made by the relevant party, as will be discussed below in connection with FIG. 19A. An exemplary interface implementing the bidding and/or invitation to collaborate 252 is shown at 262 of FIG. 18. And as mentioned above, screen 264 of FIG. 19A permits a bidder to select desired privacy settings, including whether or not his or her bids will be posted anonymously and whether or not the proposer will be permitted to share any of his or her information with other users. The system may then enable the user to review and approve the bid in a conventional manner, after which the bid will be published to the site where it may be viewed by the proposer and/or other users.

Turning now to FIG. 19B, in particular aspects, VAP 108 is configured to conveniently permit users to collaborate with one another at the bidding stage. For example, VAP 108 may generate a user interface screen 266, which enables a user to open his or her bid, e.g., at tab 267, to solicit collaboration from other users. In the particular example shown, the user has provided minimum and maximum total bid amounts, and has indicated that he or she is seeking collaborators for up to 20 percent of the project. This screen also indicates that the user has received two offers for collaboration, for 10 percent each.

As shown in FIG. 19C, user interface screen 268 indicates that the user may accept, decline, or send a counteroffer to each of the potential collaborators. Provision is also provided for the user to revise the total bid, e.g., using a slider bar as shown. In particular aspects, any bid revision will be applied to all of the collaborators, e.g., in proportion to the collaborators' percent interest in the total project. Moreover, as mentioned above, various aspects may be configured to require agreement by all of the collaborators prior to any bid revision being forwarded to the proposer.

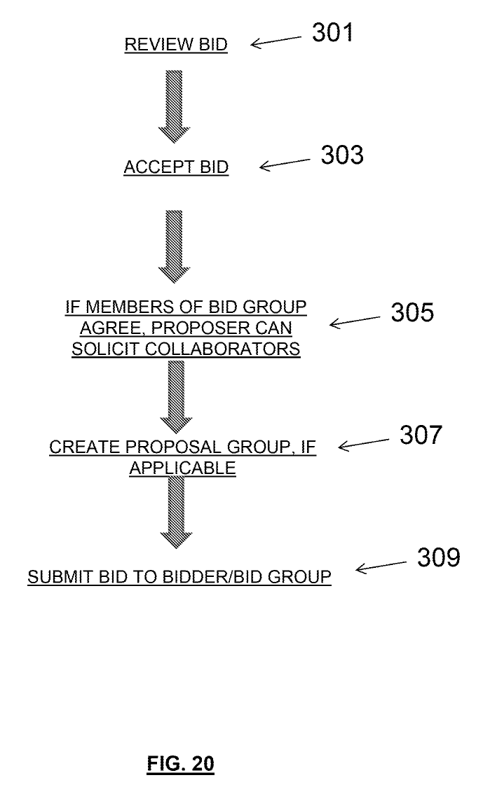

Referring now to FIG. 20, an exemplary bidding process, in which various aspects up to the point at which a winning bidder (or bidder group) is identified, is shown and described. In accordance with one aspect, the proposer may review and consider the bid at 301. As shown and described hereinabove, facility 10 may provide the proposer with convenient access to many criteria that may be used during this consideration. Such criteria may include the rating and reputation of the bidder/bidder group, the bid amount, the bid group composition, and whether or not the bid group has given him permission to share their information (cost sharing). Upon identification of a winning bid, the bid may be accepted/awarded at 303, and optionally, with the consent of the bidder/bidder group, the proposer may solicit collaborators at 305, e.g., to potentially share the cost of the proposal. In this regard, in a manner similar to the collaboration process on the bid side, the proposer may share the information provided in the winning bid with other users, either through invitation, or publicly via the VAP 108/module 104. The system may then present an interface screen outlining the proposed cost allocation among various proposal group users at 307. In particular aspects, once the proposer/proposer group accepts the cost and project terms, the bid details are sent back to the bidder/bid group at 309 for confirmation. In this regard, it is noted that facility 10 facilitates confirmation messages (e.g., email or instant message) to be exchanged, while proposers and bidders complete the project tasks. The proposal may then be closed, and a copy may be archived by facility 10. It should also be noted that the proposal may be submitted in accordance with any number of formats known to those skilled in the art of live and virtual auctions, without departing from the scope of the present invention. For example, proposals may be submitted as either reserve or no-reserve auctions, or combinations thereof with or without the minimums or maximums discussed hereinabove. A proposer may or may not be obligated to accept a bid, depending on the particular auction parameters set when the proposal was originally posted to the system. Proposals may expire after as predetermined period of time, which may be up to three to four weeks or more.

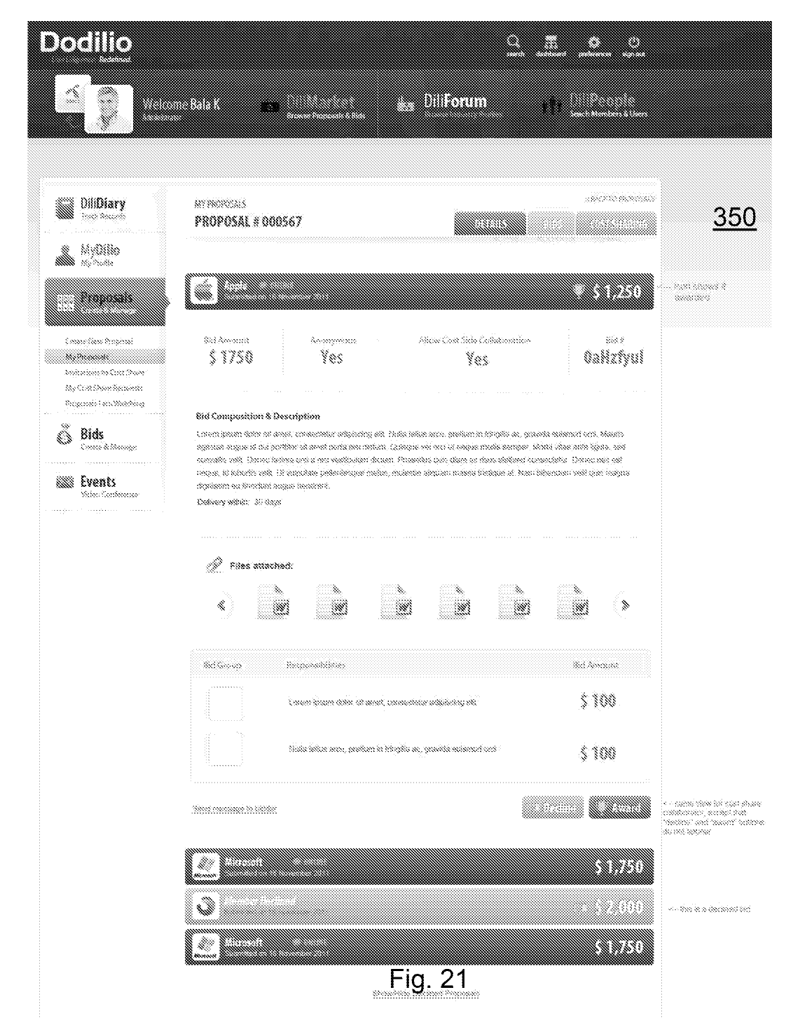

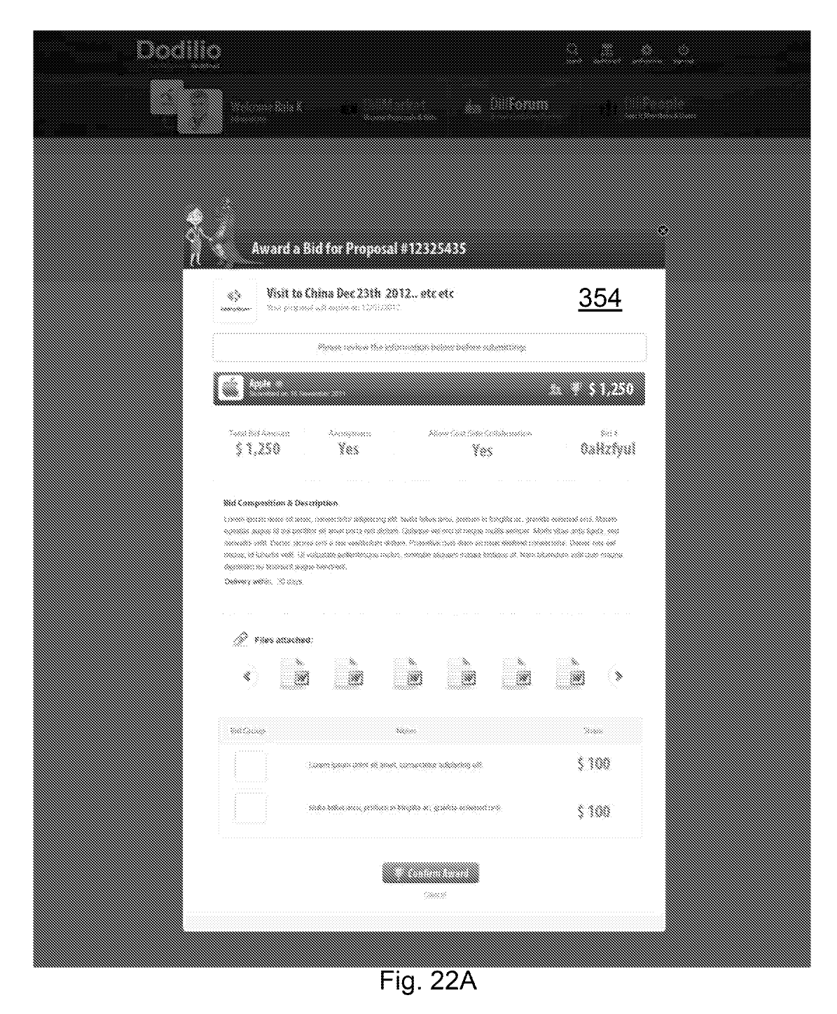

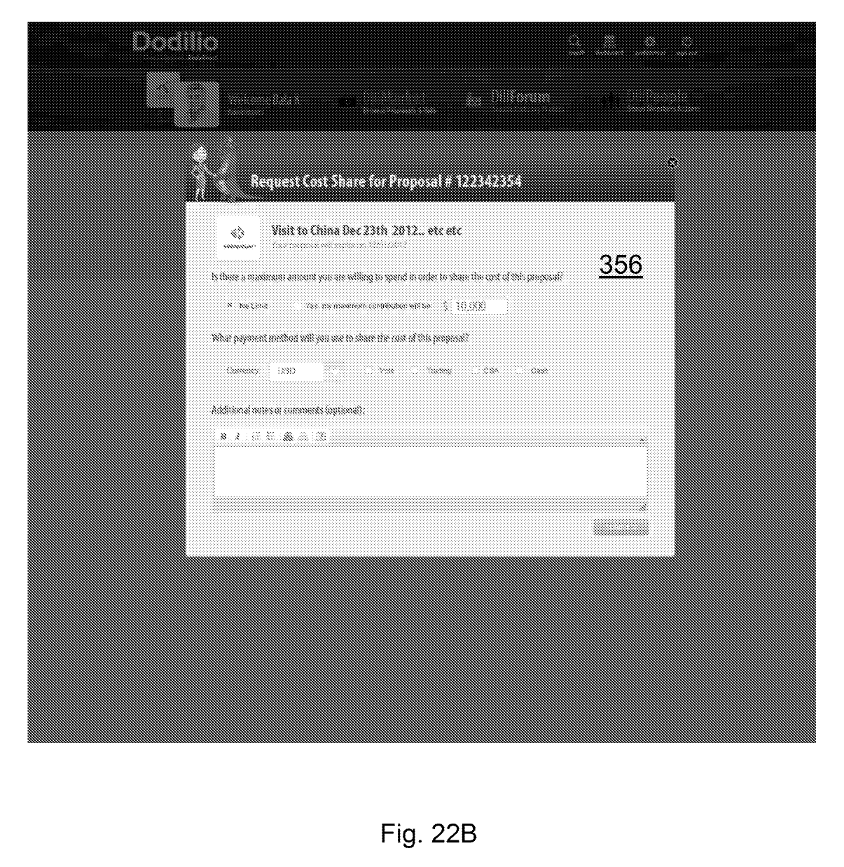

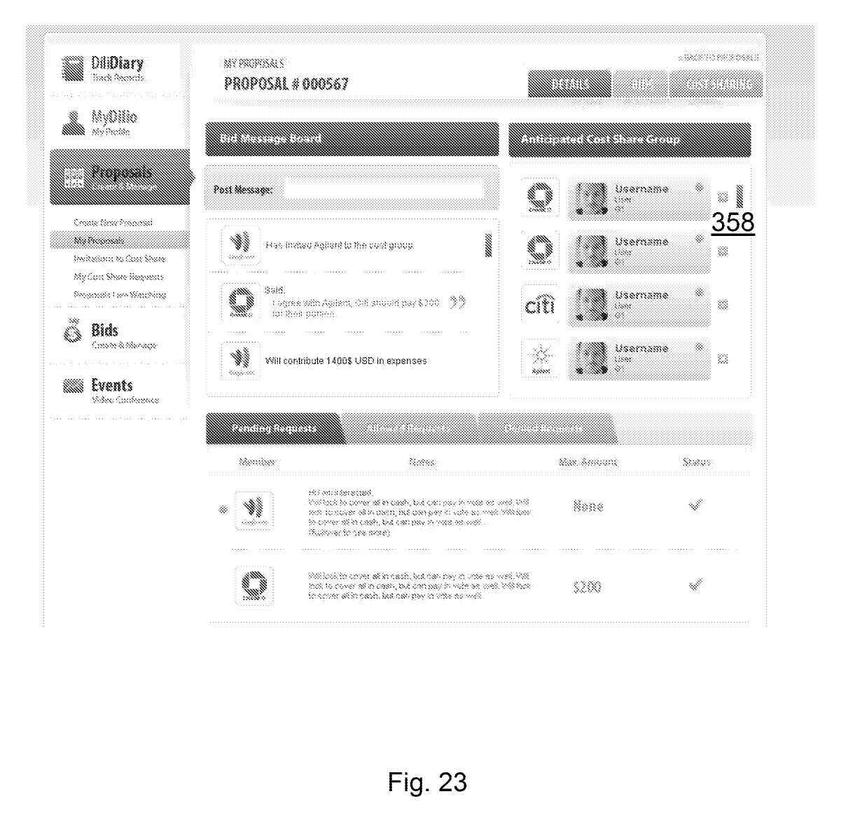

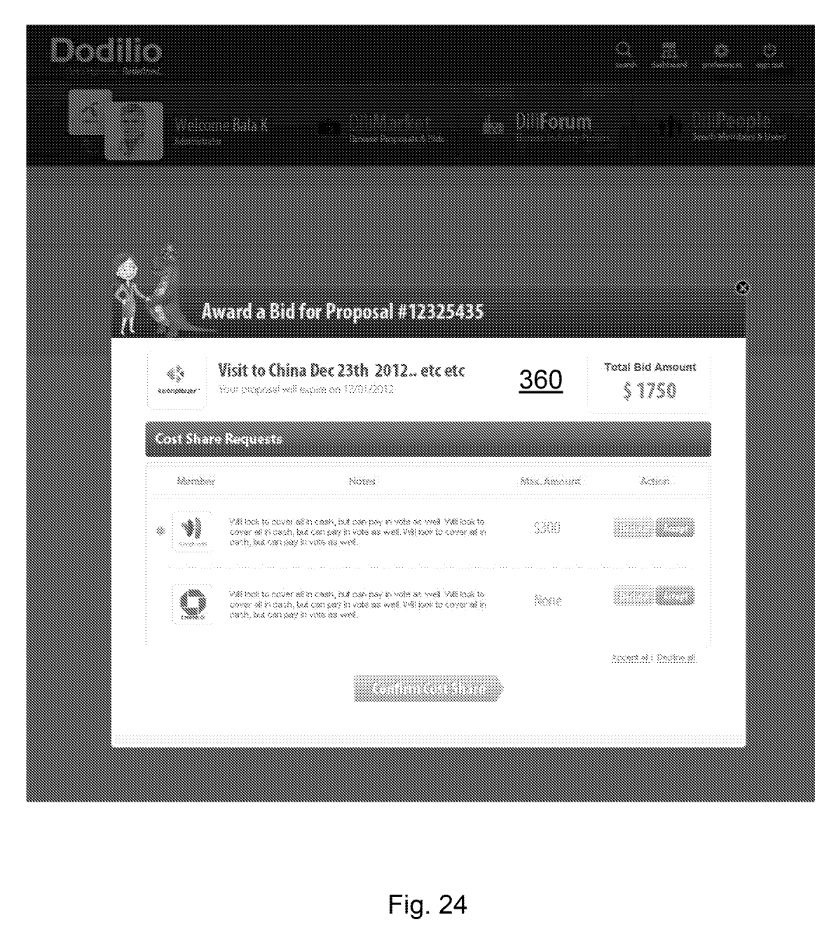

Examples of the various user interfaces presented by facility 10 to implement the steps of FIG. 20 are shown in FIGS. 21-24. For example, a screen 350 for bid review 301 is shown in FIG. 21. A screen 354 for bid acceptance/award 303 is shown in FIG. 22A. A screen 356 presented to potential proposal collaborators at 305, by which they may respond, is shown at FIG. 22B. A screen 358 by which cost share requests from various users may be reviewed 307 and coordinated is shown at FIG. 23, and an exemplary screen 360 by which cost share requests may be accepted and confirmed (and optionally automatically forwarded to the bidder/bid group) 309 is shown at FIG. 24.

The skilled artisan should recognize that various additional user interface screens, such as those displaying summaries/thumbnails of substantially any of the elements shown and discussed herein, including currently pending and/or closed proposals, bids, requests, etc., and which may be selected to drill down to more detailed information, may be provided without departing from the scope of the present invention.

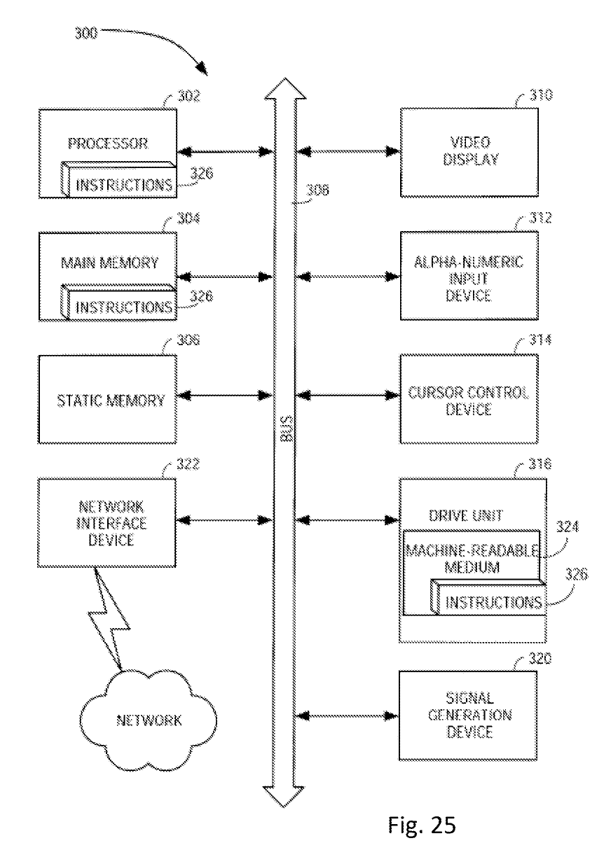

FIG. 25 shows a diagrammatic representation of a machine in the exemplary form of a computer system 300 within which a set of instructions, for causing the machine to perform any one of the methodologies and/or implement the various modules discussed above, may be executed. In alternative aspects, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322.

Thus, a method and apparatus for generating custom financial products and services in a network-based transaction facility have been described. Although the present invention has been described with reference to specific exemplary aspects, it will be evident that various modifications and changes may be made to these aspects without departing from the broader spirit and scope of the invention. Accordingly, the specification and drawings are to be regarded in an illustrative rather than a restrictive sense.

Furthermore, aspects of the present invention include a computer program code-based product, which includes a computer readable storage medium having program code stored therein which can be used to instruct a computer to perform any of the functions, methods and/or modules associated with the present invention. The computer readable medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static, dynamic, or volatile memory or data storage devices, but does not include a transitory signal per se.

It should be noted that the various modules and other components of the aspects discussed hereinabove may be configured as hardware using, for example, hardware components, such as application specific integrated circuits (ASICs). The various modules and other components may also be implemented using software, e.g., as computer readable code stored in any suitable non-transitory computer usable medium, such as ROM, RAM, flash memory, phase-change memory, magnetic disks, etc., and/or as combinations thereof, without departing from the scope of the present invention.

It should be further understood that any of the features described with respect to one of the aspects and/or user interface screens described herein may be similarly applied to any of the other aspects described herein without departing from the scope of the present invention.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented system in a client-server environment, for conducting and disseminating financial research products and services among users in an investment community, the system comprising:
a server configured for being communicably coupled to a plurality of users' client computers, the server including:
a social network module configured to store electronic user files for each of the users, and to generate a network user interface configured to enable communication among the users via the users' client computers in at least one of real time and asynchronously;
a forum module configured to store and display on a forum user interface, selected media including selections of the communication among the users, for access at the client computers;
a virtual auction module configured to generate an auction user interface by which users are able to generate proposals for desired financial research products or services, view the proposals, bid on the proposals, and collaborate on the proposals, in at least one of real-time and asynchronously;
a payment module configured to process payments between the users;
a dashboard module configured to generate an electronic dashboard configured to track and selectively display status of the electronic user files, including enabling users to selectively access the social network, forum and virtual auction modules in real-time.

2. The system of claim 1, comprising one or more computers configured to actuate one or more of said modules.

3. The system of claim 1, wherein said virtual auction module is configured to implement a proposal generation process including receiving and capturing: identification information for a proposer; information on whether the proposal is public or private; and information on whether the proposal is to be offered in an auction format or a fixed-price format.

4. The system of claim 1, wherein the virtual auction module is configured to permit users to collaborate on one or more of generating the proposals and making payment for the desired financial research products or services.

5. The system of claim 1, wherein the virtual auction module is configured to permit users to collaborate on bids on the proposals.

6. The system of claim 5, wherein said virtual auction module is further configured to implement a proposal identification process which includes enabling a user to: search and identify one or more proposal of interest; prepare a bid in response to the proposal of interest; publish invitations to collaborate on the bid with other users; select a bid group of collaborating users; and submit the bid.

7. The system of claim 6, wherein said virtual auction module is further configured to permit a proposer to solicit collaborators.

8. The system of claim 7, wherein said virtual auction module is further configured to require permission of the bidder prior to enabling the proposer to solicit collaborators.

9. The system of claim 1, wherein said virtual auction module is further configured to implement a bid review process including enabling a proposer to review bids, accept and reject bids, solicit collaborators to share costs, and select a proposal group of collaborating users.

10. The system of claim 1, further comprising a login module configured to enforce permissions to provide selective access to the server by one or more of the users at one or more of the users' client computers.

11. The system of claim 10, wherein the login module is configured to permit users to access the system as at least one of an individual user and an enterprise user.

12. The system of claim 11, being configured to permit users to perform selected interactions anonymously.

13. The system of claim 1, wherein said forum module comprises a pick module configured to receive user-generated investment ideas, present the investment ideas to other users, and to engage said payment module to process payments from the other users in exchange for receipt of the investment ideas.

14. The system of claim 13, wherein said pick module is configured to receive user-generated investment ideas in the form of stock picks, present the stock picks to the other users, and to engage said payment module to process payments from the other users based on accuracy of the stock picks.

15. The system of claim 1, wherein said forum module comprises a web crawler module configured to capture news from a plurality of sources including selected RSS feeds, based on predetermined search criteria.

16. The system of claim 1, wherein said forum module comprises a file share module configured to communicably couple a client machine to a remote network-based file storage device, wherein users are permitted to upload files to the storage device for sharing with other users.

17. The system of claim 1, wherein said forum module comprises an event module configured to store and display listings of events to which users are at least one of invited, attending, and hosting.

18. The system of claim 1, wherein said dashboard module comprises an interest module configured to present a gauge of users' interest in one another, based on the users' actions performed on the system.

19. The system of claim 18, wherein said interest module comprises an activity module configured to capture users' activity on the system.

20. The system of claim 1, wherein said dashboard module comprises a trends module configured to capture, aggregate, and display one or more summaries of topics being discussed by users.

21. The system of claim 20, wherein said trends module is configured to customize the summaries for a particular user by capturing, aggregating, and displaying the one or more summaries of topics being discussed by users within a contact list maintained by the particular user.

22. The system of claim 1, wherein said dashboard module comprises a discovery module configured to capture and display conversations taking place via the system, involving user-selected criteria.

23. The system of claim 1, wherein said dashboard module comprises a buzz module configured to capture and display conversations in which a particular company name is mentioned.

24. The system of claim 1, wherein said dashboard module is configured to provide user access to a file share module configured to communicably couple a client machine to a remote network-based file storage device, wherein users are permitted to upload files to the storage device for sharing with other users.

25. The system of claim 1, wherein said dashboard module comprises a profile module configured to enable users to create and edit profiles for display to other users.

26. The system of claim 1, wherein said payment module is configured to process payments between the users in the form of credits for 28E soft dollar accounts.

27. A computer implemented method in a client-server environment, for conducting and disseminating financial research products and services among users in an investment community, the method comprising, with a server computer:
(a) storing electronic user files for each of the users, and generating a network user interface configured to enable communication among the users via the users' client computers in at least one of real time and asynchronously;
(b) storing and displaying on a forum user interface, selected media including selections of the communication among the users, for access at the client computers;
(c) generating an auction user interface by which users are able to generate proposals for desired financial research products or services, view the proposals, bid on the proposals, and collaborate on the proposals, in at least one of real-time and asynchronously;
(d) processing payments between the users;
(e) generating an electronic dashboard configured to track and selectively display status of the electronic user files, including enabling users to selectively access the social network, forum and virtual auction modules in real-time.

28. The method of claim 27, wherein said generating (c) further comprises implementing a proposal generation process including receiving and capturing: identification information for a proposer; information on whether the proposal is public or private; and information on whether the proposal is to be offered in an auction format or a fixed-price format.

29. The method of claim 27, wherein said generating (c) further comprises permitting users to collaborate on one or more of generating the proposals and making payment for the desired financial research products or services.

30. The method of claim 27, wherein said generating (c) further comprises permitting users to collaborate on bids on the proposals.

31. The method of claim 30, wherein said generating (c) further comprises implementing a proposal identification process which includes enabling a user to: search and identify one or more proposal of interest; prepare a bid in response to the proposal of interest; publish invitations to collaborate on the bid with other users; select a bid group of collaborating users; and submit the bid.

32. The method of claim 31, wherein said generating (c) further comprises permitting a proposer to solicit collaborators.

33. The method of claim 32, wherein said generating (c) further comprises requiring permission of the bidder prior to enabling the proposer to solicit collaborators.

34. The method of claim 27, wherein said generating (c) further comprises implementing a bid review process including enabling a proposer to review bids, accept and reject bids, solicit collaborators to share costs, and select a proposal group of collaborating users.

35. The method of claim 27, further comprising configuring enforcing permissions to provide selective access to the server by one or more of the users at one or more of the users' client computers.

36. The method of claim 35, further comprising permitting users to access the system as at least one of an individual user and an enterprise user.

37. The method of claim 36, further comprising permitting users to perform selected interactions anonymously.

38. The method of claim 27, wherein said storing (b) further comprises receiving user-generated investment ideas, presenting the investment ideas to other users, and engaging said payment module to process payments from the other users in exchange for receipt of the investment ideas.

39. The method of claim 38, further comprising receiving user-generated investment ideas in the form of stock picks, presenting the stock picks to the other users, and processing payments from the other users based on accuracy of the stock picks.

40. The method of claim 27, wherein said storing (b) further comprises using a web crawler to capture news from a plurality of sources including selected RSS feeds, based on predetermined search criteria.

41. The method of claim 27, wherein said storing (b) further comprises communicably couple a client machine to a remote network-based file storage device, wherein users are permitted to upload files to the storage device for sharing with other users.

42. The method of claim 27, wherein said storing (b) further comprises storing and displaying listings of events to which users are at least one of invited, attending, and hosting.

43. The method of claim 27, wherein said generating (e) further comprises presenting a gauge of users' interest in one another, based on the users' actions performed on the system.

44. The method of claim 43, wherein said generating (e) further comprises capturing users' activity on the system.

45. The method of claim 27, wherein said generating (e) further comprises capturing, aggregating, and displaying one or more summaries of topics being discussed by users.

46. The method of claim 45, wherein said generating (e) further comprises customizing the summaries for a particular user by capturing, aggregating, and displaying the one or more summaries of topics being discussed by users within a contact list maintained by the particular user.

47. The method of claim 27, wherein said generating (e) further comprises capturing and displaying conversations taking place via the system, involving user-selected criteria.

48. The method of claim 27, wherein said generating (e) further comprises capturing and displaying conversations in which a particular company name is mentioned.

49. The method of claim 27, wherein said generating (e) further comprises communicably coupling a client machine to a remote network-based file storage device, wherein users are permitted to upload files to the storage device for sharing with other users.

50. The method of claim 27, wherein said generating (e) further comprises enabling users to create and edit profiles for display to other users.

51. The method of claim 27, wherein said processing (d) further comprises processing payments between the users in the form of credits for 28E soft dollar accounts.

52. An article of manufacture for conducting and disseminating financial research products and services among users in an investment community, said article of manufacture comprising:
a non-transitory computer usable medium having a computer readable program code embodied therein, said computer usable medium having computer readable program code for:
(a) storing electronic user files for each of the users, and generating a network user interface configured to enable communication among the users via the users' client computers in at least one of real time and asynchronously;
(b) storing and displaying on a forum user interface, selected media including selections of the communication among the users, for access at the client computers;
(c) generating an auction user interface by which users are able to generate proposals for desired financial research products or services, view the proposals, bid on the proposals, and collaborate on the proposals, in at least one of real-time and asynchronously;
(d) processing payments between the users;
(e) generating an electronic dashboard configured to track and selectively display status of the electronic user files, including enabling users to selectively access the social network, forum and virtual auction modules in real-time.
